(19) United States
(12) Patent Application Publication
(10) Pub. No.: US 2026/0004176 A1
(43) Pub. Date: Jan. 1, 2026

(54) METHODS AND SYSTEMS FOR INTER-MODULE TRANSPORT IN TRAPPED ION QUANTUM COMPUTERS

(71) Applicant: Universal Quantum LTD, Brighton (GB)

(72) Inventors: Zak David ROMASZKO, Crawley (GB); Michael NEWMAN, London (GB); Martin SIEGELE, Southampton (GB)

(21) Appl. No.: 19/181,117

(22) Filed: Apr. 16, 2025

(30) Foreign Application Priority Data
Jun. 26, 2024 (GB) 2409154.8
Jan. 8, 2025 (GB) 2500205.6

(51) Int. Cl. G06N 10/40

(52) U.S. Cl. CPC G06N 10/40

(57) ABSTRACT

Disclosed herein are trapped-ion quantum computers, trapped-ion quantum computing modules, and techniques and methods for inter-module ion transport. A trapped-ion quantum computer, may comprise a plurality of quantum computing modules, wherein each module of the plurality of quantum computing modules is fabricated on a substrate, wherein feature electrode structures on a module of the plurality of quantum computing modules extend at least partially to an edge of an inter-module gap, and wherein an ion is transported across the inter-module gap with a temperature increase of less than about 100 motional quanta and a transfer infidelity rate of less than about 0.01.

### CROSS-REFERENCE

This application claims the benefit of United Kingdom (GB) Patent Application No. 2409154.8, filed Jun. 26, 2024, and United Kingdom (GB) Patent Application No. 2500205.6, filed Jan. 8, 2025, each of which are incorporated herein in their entirety by reference.

### BACKGROUND

Quantum computing relies on the quantum mechanical properties of particles or matter to store data. The data may be represented by certain atomic ions, dubbed quantum bits or qubits, which provide a two-state quantum mechanical system. Unlike normal bits, which must be in a 0 or 1, off or on state, qubits can exist in a superposition of quantum states. When combined with entanglement of quantum states, quantum computers are able to gain significant advantage in certain problems over classical computers. One type of quantum computer, a trapped ion quantum computer, and specifically the quantum charged coupled device (QCCD) variant, relies on the transport of charged ions among a plurality of quantum computing modules to store information and perform computations. Such platforms using trapped atomic ions form an exceptional foundation on which QCs and quantum simulators can be developed.

### SUMMARY

Provided herein are trapped-ion quantum computers, trapped ion quantum computing modules, and methods for ion transport among modules of a trapped-ion quantum computer. Particular aspects herein may provide for low heat gain, high fidelity, high modularity trapped-ion quantum computers implementing intra and inter-module ion transport. Inter-module ion transport may comprise the passage of ions over gaps or discontinuities in one or both of electrode structure or pseudopotential paths. To facilitate high fidelity ion transport over such gaps or discontinuities, voltage waveforms, pseudopotential paths, module structures, manufacture techniques, post-transport ion operations, or any combination thereof may be implemented to facilitate inter-module ion transport. As such, the techniques herein allow for highly flexible, modular, scalable, robust, or any combination thereof, trapped-ion quantum computers.

In an aspect disclosed herein is a method for cooling an ion in a trapped-ion quantum computer comprising: (a) transporting the ion over an inter-module gap from a first quantum computing module to a second quantum computing module; and (b) cooling the ion using a sympathetic cooling technique.

In some embodiments, the sympathetic cooling technique comprises cooling at least one coolant ion, and wherein the coolant ion coulombically interacts with the ion. In some embodiments, the coolant ion coulombically interacts with one or more other ions. In some embodiments, the sympathetic cooling technique comprises the use of two or more coolant ions. In some embodiments, the sympathetic cooling technique comprises one or more methods selected from the group consisting of Doppler cooling, sideband cooling, wire-mediated sympathetic cooling, and electromagnetically induced transparency cooling (EIT). In some embodiments, a coolant ion used in the sympathetic cooling technique is transported with the ion. In some embodiments, the inter-module gap is at least about 10 μm. In some embodiments, prior to (a) the method comprises applying a voltage waveform to a plurality of electrodes, wherein the plurality of electrodes is configured to trap a plurality of ions comprising at least the ion. In some embodiments, the voltage waveform comprises an inter-module transport waveform. In some embodiments, the transporting in (a) comprises applying said inter-module transport waveform to transport said ion. In some embodiments, subsequent to (a) the method comprises measuring a temperature with a sensor. In some embodiments, if the temperature is greater than a threshold (b) is performed. In some embodiments, subsequent to (b) the method comprises updating said inter-module transport waveform based on said temperature. In some embodiments, the method is performed during a computation of the trapped-ion quantum computer. In some embodiments, the method is performed during a calibration phase of the trapped-ion quantum computer.

In an aspect disclosed herein is a method for ion transport in a trapped-ion quantum computer comprising: (a) transporting an ion across an inter-module gap using a voltage waveform; (b) after transporting the ion, measuring a temperature of the ion; and (c) updating the voltage waveform based on the temperature of the ion.

In some embodiments, (c) is performed during a computation of the trapped-ion quantum computer. In some embodiments, (c) is performed during a calibration phase of the trapped-ion quantum computer. In some embodiments, (c) is performed substantially without stopping a computation of the trapped-ion quantum computer or a calibration phase of the trapped-ion quantum computer. In some embodiments, (c) is iteratively updated until a threshold condition is reached. In some embodiments, the threshold condition is a number of iterations. In some embodiments, the threshold condition is a maximum barrier height. In some embodiments, the threshold condition is a maximum value of a gradient of a potential energy barrier across the inter-module gap. In some embodiments, the voltage waveform is updated to provide a transport path comprising a maximum barrier height of less than about 10 meV. In some embodiments, the voltage waveform is updated to provide a transport path comprising a potential barrier gradient of less than about 1 meV per micron. In some embodiments, (c) is based on an output of a machine learning model. In some embodiments, (c) is based on a gradient descent calculation. In some embodiments, (b) comprises measuring a population of blue and red sidebands of a state of the ion in order to extract a temperature. In some embodiments, the sidebands are motional sidebands. In some embodiments, (b) comprises applying electromagnetic energy to the ion to induce Rabi flopping on a motional sideband of a state of the ion. In some embodiments, (b) comprises fitting the motional sideband to extract the temperature. In some embodiments, (b) comprises measuring a Doppler recooling signal from the ion. In some embodiments, the Doppler recooling signal comprises applying electromagnetic energy to the ion and measuring a time for Doppler shift of the ion to return to a Doppler limited profile. In some embodiments, the method further comprises subsequent to (c) identifying that the voltage waveform meets a threshold condition. In some embodiments, the threshold condition comprises a finding that the kinetic energy of the ion is less than a trap depth. In some embodiments, the threshold condition comprises a finding that the temperature of the ion is approaching or less than a Doppler limit.

In an aspect disclosed herein is a system for cooling an ion in a trapped-ion quantum computer comprising; a plurality of quantum computing modules, wherein the plurality of quantum computing modules comprise a plurality of electrodes configured to trap a plurality of ions; and a controller communicatively coupled to a plurality of digital-to-analog converters (DACs), wherein the DACs are configured to transmit a voltage waveform to the plurality of electrodes, wherein the controller is configured to: transport an ion of the plurality of ions across an inter-module gap using a voltage waveform; after transporting the ion, measure a temperature of the ion; and update the voltage waveform based on the temperature of the ion. In some embodiments, the controller is a processor, an ASIC, a CPU, a GPU, or an FPGA. In some embodiments, the system is configured to perform any method disclosed herein.

In an aspect disclosed herein is a module for a modular ion trapping system comprising: a substrate; and a plurality of electrodes above a surface of the substrate and distributed along a direction perpendicular to a direction of transport of the one or more ions, wherein the plurality of electrodes are configured to trap one or more ions, wherein the plurality of electrodes comprise: at least two RF electrodes disposed in an axis parallel to the direction of transport of the one or more ions; and at least three RF ground electrodes disposed in one or more axes parallel to the direction of transport of the one or more ions, wherein a first RF ground electrode of the at least three RF ground electrodes is between the at least two RF electrodes, and wherein a second RF ground electrode and a third RF ground electrode are outside of the at least two RF electrodes.

In some embodiments, the second RF ground electrode and the third RF ground electrode form a single electrode disposed in a plane parallel to the surface of the substrate and below the at least two RF electrodes. In some embodiments, an RF ground electrode of the at least three RF ground electrodes comprises a plurality of sub-electrodes configured to provide one or both of confinement of an ion of the one or more ions along the direction of transport of the one or more ions or transport the ion of the one or more ions along the direction of transport of the one or more ions. In some embodiments, the plurality of sub-electrodes comprises at least three sub-electrodes. In some embodiments, an oscillating voltage is applied to the at least two RF electrodes. In some embodiments, a substantially constant voltage is applied to one or more of the at least three RF ground electrodes. In some embodiments, the at least two RF electrodes are configured to confine an ion of the one or more ions in a direction perpendicular to the direction of transport of the one or more ions. In some embodiments, the at least two RF electrodes provide a pseudopotential confinement of an ion of the one or more ions. In some embodiments, the second and the third RF ground electrode are grounds. In some embodiments, the second and the third RF ground electrode are at a substantially constant voltage. In some embodiments, the module further comprises a fourth and a fifth RF ground electrode further exterior to the second electrode and the third electrode. In some embodiments, the fourth and the fifth RF ground electrodes are grounds. In some embodiments, the first RF ground electrode between the at least two RF electrodes is a ground. In some embodiments, the first RF ground electrode between the at least two RF electrodes is at a substantially constant voltage. In some embodiments, the first RF ground electrode comprises at least two first RF ground electrodes. In some embodiments, the at least two first RF ground electrodes are at substantially equal voltage. In some embodiments, the at least two first RF ground electrodes are at different voltages. In some embodiments, the first RF ground electrode comprises at least three first RF ground electrodes distributed along a direction perpendicular to a direction of transport of the one or more ions. In some embodiments, the at least three first RF ground electrodes comprises: (1) a central RF ground electrode, and (2) two outer RF ground electrodes exterior to the central RF ground electrode and between the at least two RF electrodes. In some embodiments, the central RF ground electrode comprises a substantially constant voltage. In some embodiments, the at least two outer RF ground electrodes are configured to impart a rotation. In some embodiments, the plurality of electrodes lie in a plurality of planes above a surface of the substrate and wherein the plurality of planes are coplanar. In some embodiments, the plurality of electrodes lie in a plurality of planes above a surface of the substrate and wherein the plurality of planes are non-coplanar. In some embodiments, a first plane and a second plane of a plurality of planes are separated by at least about 1 μm. In some embodiments, a first plane and a second plane of a plurality of planes are separated by at least about 5 μm. In some embodiments, the first RF ground electrode is closer to a plane of the substrate than a plane of the at least two RF electrodes. In some embodiments, relative heights of the plurality of electrodes above the substrate are selected to increase a gap between neighboring electrodes. A larger gap between neighboring electrodes may provide particular utility by mitigating a risk of electrical breakdown, easing fabrication constraints, or both. In some embodiments, the at least two RF electrodes are configured to carry a radiofrequency (RF) waveform. In some embodiments, the RF waveform is configured to transport the ion along the direction of transport of the one or more ions. In some embodiments, the direction of transport of the one or more ions approaches an end of the substrate at an edge. In some embodiments, the plurality of electrodes terminates substantially evenly at the edge along the direction of transport of the one or more ions. In some embodiments, the at least two RF electrodes extend beyond other electrodes in the plurality of electrodes at the edge along the direction of transport of the one or more ions. In some embodiments, a distance which the at least two RF electrodes extend beyond the substrate is tuned to allow module-to-module transport. In some embodiments, the ion is configured to transport above the substrate and at least some of the plurality of electrodes. In some embodiments, the module further comprises one or more vias between electrodes of the plurality of electrodes. In some embodiments, the module further comprises one or more insulators between electrodes of the plurality of electrodes. In some embodiments, the module further comprises driving circuitry for the plurality of electrodes. In some embodiments, the module further comprises a plurality of modules configured to allow module-to-module transport.

In an aspect disclosed herein is a module for a modular ion trapping system comprising: a substrate; and a plurality of electrodes above a surface of the substrate and distributed along a direction perpendicular to a direction of transport of the one or more ions, wherein the plurality of electrodes are configured to trap one or more ions, wherein the plurality of electrodes comprise: at least two RF electrodes disposed in a first axis parallel to the direction of transport of the one or more ions; a first RF ground electrode disposed between the at least two RF electrodes and in a second axis parallel to the direction of transport of the one or more ions; and a second RF ground electrode disposed between the substrate and one or both of the at least two RF electrodes or the first RF ground electrode.

In an aspect disclosed herein is a module for a modular ion trapping system comprising: a first plane along a direction of ion transport and above a surface of a substrate; a second plane along the direction of ion transport and above the surface of the substrate; and a plurality of electrodes forming an ion trap, wherein a first portion of the plurality of electrodes is disposed within the first plane and a second portion of the plurality of electrodes is disposed within the second plane, and wherein the first plane is not coplanar with the second plane above the surface of the substrate.

In some embodiments, a first plane axis and a second plane axis are both along the direction of ion transport and wherein the first plane axis and the second plane axis are separated by at least about 1 um. In some embodiments, the plurality of electrodes comprises at least two RF electrodes and at least three RF ground electrodes. In some embodiments, a separation between two electrodes of the plurality of electrodes is at least about 5 μm. In some embodiments, the module is a module as described herein.

In an aspect disclosed herein is a module for a modular ion trapping system comprising: a first plane perpendicular to a direction of ion transport and parallel to an edge of a substrate; a second plane perpendicular to the direction of ion transport and parallel to the edge of the substrate; and a plurality of electrodes forming an ion trap at the edge of the substrate, wherein a first portion of the plurality of electrodes is disposed within the first plane and a second portion of the plurality of electrodes is disposed within the second plane, and wherein the first plane is not coplanar with the second plane.

In some embodiments, a first plane axis and a second plane axis are both perpendicular to the direction of ion transport and wherein the first plane axis and the second plane axis are separated by at least about 1 um. In some embodiments, the plurality of electrodes comprises at least two RF electrodes and at least three RF ground electrodes. In some embodiments, a separation between two electrodes of the plurality of electrodes is at least about 5 μm.

In one aspect disclosed herein is a system for trapped ion quantum computing, comprising: at least two modules each comprising an ion trap, wherein the at least two modules are die-bonded to a common package material, and wherein the at least two modules are connected by an electric field link.

In some embodiments, an interconnect material is disposed between a module of the at least two modules and the common package material. In some embodiments, the interconnect is configured to provide a substantially coplanar alignment. In some embodiments, the interconnect comprises a BGA, a PGA, a bumps array, a polymer spacer, a metal pillar, a metal solder, or a spring pin. In some embodiments, the interconnect is partially compressible. In some embodiments, a first edge of a first ion trap is laterally offset from a second edge of a second ion trap by at most about 10 μm. In some embodiments, a first edge of a first ion trap is vertically offset from a second edge of a second ion trap by at most about 10 μm. In some embodiments, a coherent infidelity associated with ion transport between a first ion trap and a second ion trap is less than about 5%. In some embodiments, a transport infidelity associated with ion transport between a first ion trap and a second ion trap is less than about 5%. In some embodiments, the system for trapped ion quantum computing comprises a portion of a trapped ion quantum computer. In some embodiments, a substrate of a module of the at least two modules is die-bonded to the package material. In some embodiments, each ion trap comprises one or more of the following surface features: a section for transporting an ion from one position to another or a plurality of electrodes configured to trap an ion. In some embodiments, the plurality of electrodes are configured to perform one or more operations on the ion within the ion trap. In some embodiments, the common package material comprises silicon, glass, ceramic, organic semiconductor package, or a PCB material. In some embodiments, a module of the at least two modules forms a second electric field link with a third module on a second package material. In some embodiments, the module forms a third electric field link with a fourth module on a third package material. In some embodiments, an edge-to-edge distance between the common package material and the second or third package material is less than 150 microns. In some embodiments, top surfaces of adjacent modules are coplanar to within less than about 10 microns. In some embodiments, the system is fabricated according to multi-chip module packaging principles.

In an aspect disclosed herein is a method for transferring an ion between a first quantum computing module and a second quantum computing module comprising: transporting an ion to a first pseudopotential minima of the first quantum computing module; providing a second pseudopotential minima at the second quantum computing module, wherein the second pseudopotential minima is substantially aligned with the first pseudopotential minima in one or two directions; and switching off the first pseudopotential minima, thereby transferring the ion from the first quantum computing module to the second quantum computing module.

In some embodiments, the first quantum computing module and the second quantum computing module are substantially colinear. In some embodiments, the first quantum computing module and the second quantum computing module are substantially perpendicular. In some embodiments, the first quantum computing module and the second quantum computing module are substantially parallel.

In an aspect disclosed herein is a method of correcting phase accumulation in trapped-ion quantum computer comprising: (a) transporting an ion over an inter-module gap from a first quantum computing module to a second quantum computing module; (b) measuring a phase accumulation of the ion; and (c) applying a phase correction technique to the ion based on the phase accumulation of the ion. In some embodiments, the ion comprises a qubit.

In some embodiments, the method further comprises, subsequent to (b) storing the phase accumulation value. In some embodiments, the measuring in (b) comprises a fluorescence measurement. In some embodiments, the measuring in (b) is repeated to reach adequate measurement statistics. In some embodiments, the phase correction technique comprises exposing the ion to an electro-magnetic field. In some embodiments, the electro-magnetic field comprises a microwave field. In some embodiments, the electro-magnetic field is generated by a laser. In some embodiments, the phase correction technique comprises moving the ion through a magnetic field gradient. In some embodiments, the electro-magnetic field in (c) is configured to change a phase of the ion. In some embodiments, the phase correction technique comprises adding an additional phase term in a subsequent logical operation.

In one aspect disclosed herein is a trapped-ion quantum computer, the trapped-ion quantum computer comprising a plurality of quantum computing modules, wherein each module of the plurality of quantum computing modules is fabricated on a substrate, wherein feature electrode structures on a module of the plurality of quantum computing modules extend at least partially to an edge of an inter-module gap, and wherein an ion is transported across the inter-module gap with a temperature increase of less than about 100 motional quanta and a transfer infidelity rate of less than about 0.01. In some embodiments, the inter-module gap is greater than about 10 μm. In some embodiments, two adjacent modules of said plurality of quantum computing modules comprise substantially coplanar alignment. In some embodiments, the substantially coplanar alignment comprises a lateral offset of less than about 10 μm. In some embodiments, the substantially coplanar alignment comprises a vertical offset of less than about 10 μm. In some embodiments, a quantum computing module of said plurality of quantum computing modules comprises at least two RF electrodes and at least three RF ground electrodes. In some embodiments, a first amplitude of a first RF electrode signal of a first quantum computing module of the plurality of quantum computing modules is substantially the same as that of a second amplitude of a second RF electrode signal of a second quantum computing module of the plurality of quantum computing modules. In some embodiments, a difference between the first amplitude and the second amplitude is about less than about 5% In some embodiments, a first phase of a first RF electrode signal of a first quantum computing module of the plurality of quantum computing modules is substantially the same as that of a second phase of a second RF electrode signal of a second quantum computing module of the plurality of quantum computing modules. In some embodiments, an offset of the first phase and the second phase is less than about 5 degrees. In some embodiments, the ion is a Yb ion. In some embodiments, the ion is a Yb ion, a Ba ion, a Mg ion, a Ca ion, Sr ion, or a Be ion. In some embodiments, the ion comprises a two-state quantum mechanical system. In some embodiments, a first surface of the quantum computing module comprises the feature electrode structures and a second surface of the quantum computing module comprises electrical connections, and wherein the first and second surfaces are on opposite sides of the quantum computing module.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure.

Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents and patent applications incorporated by reference contradict the disclosure contained in the specification, the specification is intended to supersede or take precedence over any such contradictory material.

### BRIEF DESCRIPTION OF THE DRAWINGS

The novel features of the inventive concepts are set forth with particularity in the appended claims. A better understanding of the features and advantages of the present inventive concepts will be obtained by reference to the following detailed description that sets forth illustrative embodiments, in which the principles of the inventive concepts are utilized, and the accompanying drawings (also “Figure” and “FIG.” herein), of which:

FIG. 1 shows an example ion transport between two quantum computing modules according to one or more embodiments herein;

FIG. 2 shows an example of a method for voltage waveform generation based on an ion temperature according to one or more embodiments herein;

FIG. 3 shows an example of a method for pseudopotential path selection based on a pseudopotential barrier height according to one or more embodiments herein;

FIG. 4A shows an example of a method for qubit phase correction according to one or more embodiments herein;

FIG. 4B shows an example of a method for storing qubit phase accumulation according to one or more embodiments herein;

FIG. 4C shows an example of a method for qubit phase correction according to one or more embodiments herein;

FIG. 4D shows an example of a method for qubit phase correction according to one or more embodiments herein;

FIG. 5 shows an example of state tomography according to one or more embodiments herein;

FIG. 6A shows an example of a cross-section of an edge electrode structure according to one or more embodiments herein;

FIG. 6B shows an example of a top view of an edge electrode structure according to one or more embodiments herein;

FIG. 7A shows an example of a plurality of cross sections of edge electrode structures according to one or more embodiments herein;

FIG. 7B shows an example of an edge electrode structure with a buried RF ground electrode according to one or more embodiments herein;

FIG. 8A shows an example of a cross-section of an edge electrode structure with more than one layer of electrodes according to one or more embodiments herein;

FIG. 8B shows an example of a top view of an edge electrode structure with a portion of the electrodes nearer to an edge of a quantum computing module than another portion of the electrodes according to one or more embodiments herein;

FIG. 9 shows a side profile cross-section of a module according to one or more embodiments herein;

FIG. 10 shows an example of a pseudopotential switch with perpendicular transport paths according to one or more embodiments herein;

FIG. 11 shows an example of a pseudopotential switch with a bridging quantum computing module according to one or more embodiments herein;

FIG. 12 shows a plurality of pseudopotential switch configurations according to one or more embodiments herein;

FIG. 13 shows an example of backside electrical connections according to one or more embodiments herein;

FIG. 14 shows an example of a plurality of modules die-bonded to a package material according to one or more embodiments herein;

FIG. 15A shows an example of a tile of quantum computing modules according to one or more embodiments herein;

FIG. 15B shows an example of a tile of quantum computing modules according to one or more embodiments herein;

FIG. 15C shows an example of a plurality of tiles of quantum computing modules according to one or more embodiments herein;

FIG. 15D shows an example of track-alignment of a plurality of tiles of quantum computing modules according to one or more embodiments herein;

FIG. 16 shows an example of quilt-stitching according to one or more embodiments herein;

FIG. 17A shows an example of an electrode structure according to one or more embodiments herein;

FIG. 17B shows an example of an electrode structure according to one or more embodiments herein;

FIG. 18 shows an example of a classical computer system according to one or more embodiments herein;

FIG. 19 shows a plot illustrating the effect of RF electrode width to RF ground electrode width on secular frequency, trap depth, and pseudopotential barrier height according to one or more embodiments herein;

FIG. 20A shows an example of a quantum computing module with extending electrodes and ground plane layer according to one or more embodiments herein;

FIG. 20B shows an example of the effects on maximal pseudopotential barrier height as a function of electrode, ground plane layer, or both, extension beyond substrate according to one or more embodiments herein;

FIG. 21 shows an example of an impact of a lateral offset between two quantum computing modules on a maximal pseudopotential barrier along an ion transport path between the two modules according to one or more embodiments herein;

FIG. 22 shows an illustrative ion trap through various stages of fabrication according to one or more embodiments herein;

FIG. 23A shows an illustrative system with two modules die-bonded to a package material according to one or more embodiments herein; and

FIG. 23B shows an illustrative system with four modules die-bonded to a package material according to one or more embodiments herein.

### DETAILED DESCRIPTION

Trapped ion quantum computers provide robust, high-fidelity state preparation and readout, high fidelity universal gate operations, and long qubit coherence times. In a trapped ion quantum computer, ions may be confined in free space using electromagnetic fields. An ion in a trapped ion quantum computer may comprise a single qubit, which may exist in a superposition of two states. This superposition, when combined with entanglement of other qubit states allows a new paradigm of computing to be exploited which can lead to reduced algorithm complexity and resultantly, quicker computation. To leverage these qubits to perform computations or quantum logic gates, the ions may be transported among quantum computing tiles or modules. However, transport of ions may introduce a loss of coherence, temperature gain, or phase accumulation that may lower the fidelity of the information stored in the qubit. As such, techniques for transporting ions among trapped ion quantum computing modules or tiles in a manner that mitigates loss of fidelity, phase accumulation, or temperature gain is valuable for scaling trapped ion quantum computers.

System scalability is fundamental for large-scale quantum computers. For quantum computers based on trapped ions, architectures such as the quantum charge-coupled device (QCCD) are used to scale the number of qubits on a single device. However, the number of ions that can be hosted on existing trapped-ion quantum computers may be limited by the practical size of quantum computing modules themselves. Such limitations may be imposed by engineering complexities that impose limits on non-modular quantum computing systems. As such, in some cases herein, the connection of multiple quantum computing modules may provide an area for computation much larger than accessible with a single quantum computing module. For example, single modules may be limited by fabrication complexity on single wafers (e.g., Si wafers). This may provide for more qubits and ultimately a larger, more powerful quantum computer. Further such modularity may provide particular utility in operation of the quantum computer by mitigating the negative impact of faults on particular modules of the quantum computer. For example, tiling groups of quantum computing modules may facilitate recalibration, maintenance, repair, or replacement of faulty modules without stopping computation globally. This ability may provide opportunities for performing more computationally complex or expensive computations than otherwise possible. For example, some algorithms may take weeks or months to complete. As such, the ability to perform live (e.g., during computation) module recalibration, maintenance, repair, or replacement may confer particular advantage over techniques that aim to make larger single-wafer or single-module quantum computers.

### Overview

Disclosed herein are trapped ion quantum computers, trapped ion quantum computing modules, and methods of operation of the same. Trapped-ion quantum computing may comprise the transport or manipulation of ions by a plurality of trapped-ion quantum computing modules. Electromagnetic fields may confine and suspend ions in free space, allowing them to be transported, exposed to gating operations, detected, stored, or otherwise used in the execution of quantum computing algorithms.

In some cases, a trapped-ion quantum computer may comprise a plurality of quantum computing modules. A module of the plurality of quantum computing modules may be fabricated on a substrate. In some cases, a quantum computing module may comprise feature electrode structures. In some cases, the feature electrode structure may comprise two RF electrodes and three RF ground electrodes. The feature electrode structures may extend at least partially to an edge or inter-module gap of the module. In some cases, the substrate may recede away from the edge electrode structures proximal to an inter-module gap. Transport of an ion across an inter-module gap may comprise delivery of the ion from the edge of one quantum computing module to the edge of another quantum computing module.

In some cases, the transport of an ion across an inter-module gap may comprise a temperature increase of less than about 1, 10, 100, 1,000, 10,000, 100,000, 1,000,000, or more motional quanta. In some cases, the transport of an ion across an inter-module gap may comprise a temperature increase of less than about 50 mK, 60 mK, 70 mK, 80 mK, 90 mK, 100 mK, 110 mK, 120 mK, 130 mK, 140 mK, 150 mK, 160 mK, 170 mK, 180 mK, 190 mK, 200 mK, or less.

In some cases, an inter-module gap may be about 10 μm to about 150 μm. In some embodiments, the inter-module gap may be about 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, or more. In some embodiments, the inter-module gap may be about 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, or less.

In some cases, a first quantum computing module may be substantially coplanar with a second quantum computing module. A substantially coplanar alignment herein may comprise an offset of less than about 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, or 20 μm, in one or both of a lateral or vertical direction. In some cases, a lateral direction or a vertical direction may be perpendicular to a direction of ion transport. Additionally, or alternatively, a substantially coplanar alignment herein may comprise a rotational offset of less than about 1 degree, 2 degrees, 3 degrees, 4 degrees, 5 degrees, 6 degrees, 7 degrees, 8 degrees, 9 degrees, 10 degrees, or less in any direction. For example, relative to the first quantum computing module, the second quantum computing module may be rotated about a central axis of the first quantum computing module. In some cases, the central axis may correspond to a direction of ion transport. In another example, relative to the first quantum computing module, the second quantum computing module may be rotated about an axis perpendicular and coplanar with the central axis. In another example, relative to the first quantum computing module, the second quantum computing module may be rotated about an axis perpendicular and not coplanar to the central axis. In some cases, an offset may comprise a combination of rotations previously described.

In some cases, a two quantum computing modules may be aligned with a controlled offset. In some cases, a controlled offset may be used to reduce a maximal pseudopotential barrier height along an ion transport path. For example, a lateral offset may be used to decrease a maximal pseudopotential barrier height along an ion transport path. In some cases, this may be used to account for a decrease in escape energy for an ion along the transport path. In some cases, a lateral offset slightly larger than an inter-module gap may provide a decrease in maximal pseudopotential barrier height. In some cases, a lateral offset of a value about 1%, 2%, 3%, 4%, 5%, 6%, 7%, 8%, 9%, or 10% greater than an inter-module gap may decrease a maximal pseudopotential barrier height along an ion transport path.

In some cases, a signal of an RF electrode of a first quantum computing module may be aligned with a signal of an RF electrode of a second quantum computing module. The alignment of the RF signals may comprise a substantial alignment of the amplitude or phase of the RF signals. In some cases, the substantial alignment may comprise an amplitude difference between a first RF signal and a second RF signal of less than about 1%, 2%, 3%, 4%, 5%, 6%, 7%, 8%, 9%, 10%, 11%, 12%, 13%, 14%, or 15%. In some cases, the substantial alignment may comprise, in addition or alternatively to the amplitude alignment, a phase offset of the first RF signal and the second RF signal of less than about 1 degree, 2 degrees, 3 degrees, 4 degrees, 5 degrees, 6 degrees, 7 degrees, 8 degrees, 9 degrees, 10 degrees, or less degrees. In some cases, the first RF signal and the second RF signal may comprise a substantially similar frequency. For example, the first RF signal and the second RF signal may comprise a frequency difference of less than about 1 nHz, 1 μHz, 1 mHz, 1 Hz, 1kHz, 1 MHz, or less Hz.

In some cases, an ion as disclosed herein may comprise a Yb ion. In some cases, the ion may comprise a Yb ion, a Mg ion, a Ca ion, a Sr ion, a Ba ion, or a Be ion. In some cases, the ion may comprise ⁴⁰Ca⁺, ⁴¹Ca⁺, ⁴³Ca⁺, ¹⁷¹Yb⁺, ¹⁷⁴Yb⁺, ⁸⁸Sr⁺, ¹³⁸Ba⁺, ¹³⁷Ba⁺, ¹³³Ba⁺, ⁹Be⁺, ²⁵Mg⁺. In some cases, the ion comprises a two-state quantum mechanical system.

In some cases, a trapped-ion quantum computer implementing the systems, methods, or devices herein may comprise more than about 10, 10², 10³, 10⁴, 10⁵, 10⁶, 10⁷, or more qubits accessible to perform a quantum computation.

### Ion Transport Mechanisms

Ion transport may comprise one or both of a shuttling mechanism or a throw-and-catch mechanism. Shuttling or throw-and-catch may be used to transport an ion across an inter-module gap. In some cases, a difference between shuttling and throw-and-catch mechanisms may be described by a difference in the continuity of the pseudopotential between two quantum computing modules. In some cases, pseudopotential may be generated by a signal passed through an RF electrode used to trap the ion. In some cases, both shuttling and throw-and-catch mechanisms may be used in one trapped-ion quantum computer herein.

In some cases, the shuttling mechanism may comprise one or both of intra-tile or inter-tile ion transport. Within a quantum computing module, there may be continuous RF electrodes and hence a continuous pseudopotential. As such, the ion may be trapped at every point along a pseudopotential. In inter-module transport, the RF electrodes may be discontinuous between two quantum computing modules. However, a similar pseudopotential generated by the RF electrode of each quantum computing module involved in transport may facilitate shuttling of the ion. The generation of a suitable pseudopotential path along which to shuttle or transport the ion may be dependent on quantum computing module alignment, RF signal frequency alignment, RF signal amplitude alignment, alignment of phase of the voltage on the RF electrodes, or any combination thereof. In some cases, the pseudopotential path may comprise a dip in pseudopotential in the inter-module gap relative to the pseudopotential of the quantum computing modules involved in transport. In some cases, a pseudopotential barrier may be present in the inter-module pseudopotential. The techniques disclosed herein may provide particular utility in facilitating the shuttling mechanism of ion transport. In some cases, the shuttling mechanism may be facilitated by alignment of two quantum computing modules as described herein.

In some cases, the shuttling mechanism may comprise transporting the ion through a path of continuous or substantially continuous pseudopotential. In some cases, the pseudopotential may be parameterized, wherein the parameters of the pseudopotential may comprise a potential energy well, a potential barrier height, a potential barrier gradient, or any combination thereof.

In some cases, a potential barrier height along an ion path may be constrained. Generally, the potential barrier height along the ion path should be less than the trap depth. Further, the potential barrier height may be maintained below a threshold value to decrease the introduction of transport infidelities, temperature gain, or both. In some cases, the potential barrier height herein may be less than about 1 meV, 2 meV, 3 meV, 4 meV, 5 meV, 6 meV, 7 meV, 8 meV, 9 meV, or 10 me V.

In some cases, a potential barrier gradient along an ion path may be constrained. Generally, a larger potential barrier gradient may introduce temperature gain, transport infidelity, or both. For example, a small barrier with a large gradient may impose greater perturbations on the ion than a larger potential barrier with a less steep gradient. In some cases, the potential barrier gradient may be parameterized to be less than about 0.1 meV per micron, 0.2 meV per micron, 0.3 meV per micron, 0.4 meV per micron, 0.5 meV per micron, 0.6 meV per micron, 0.7 meV per micron, 0.8 meV per micron, 0.9 meV per micron, 1 meV per micron, 2 meV per micron, 3 meV per micron, 4 meV per micron, 5 meV per micron, 6 meV per micron, 7 meV per micron, 8 meV per micron, 9 meV per micron, 10 meV per micron, or less meV per micron.

In some cases, the throw-and-catch mechanism may be used to transport an ion. The throw-and-catch mechanism may be relatively less dependent on the continuity of the pseudopotential between two quantum computing modules than the shuttling mechanism. In throw-and-catch, the ion may be thrown from one module and caught on the other. Substantial alignment between the quantum computing modules, particularly with respect to the RF electrodes, may facilitate the throw-and-catch transport mechanism. The techniques disclosed herein may provide particular utility in facilitating the throw-and-catch mechanism of ion transport.

In some cases, throw-and-catch may be desirable as modules may be further apart from each other. However, substantial alignment between the quantum computing modules (e.g., coplanarity, RF electrode alignment) may facilitate successful ion transport. In some cases, RF electrode alignment in the throw-and-catch context may primarily indicate an axial alignment of the ion transport paths of the two quantum computing modules.

In some cases, throw-and-catch may comprise transport without active axial propulsion. In some cases, throw-and-catch may comprise transport without active radial confinement. In some cases, a position of the ion transport path may not comprise RF electrodes otherwise used during intra-module transport to shift a pseudopotential minimum during ion transport. In some cases, a position of the ion transport path may not comprise RF ground electrodes otherwise used during intra-module transport to shift an electrostatic potential during ion transport. In some cases, throw-and-catch may comprise accelerating an ion with a first subset of electrodes and decelerating the ion with a second subset of electrodes. In some cases, the first subset of electrodes is on a first side of an inter-module gap and the second subset on an opposite side of the inter-module gap. In some cases, RF ground electrodes may be used to accelerate, decelerate, or both, an ion.

Generally, description of ion transport herein may apply to transfer between intra-tile trapped-ion quantum computing modules or inter-tile trapped ion quantum computing modules. For example, a tile may comprise a plurality of quantum computing modules on a shared package and the tile may be placed in a 1D or 2D matrix of tiles. As such, ion transport as disclosed herein may be between two trapped-ion quantum computing modules on one tile or on separate tiles.

In some cases, a coherence time of an ion or qubit herein may be from about 10 ms to about 300,000 ms. In some cases, a coherence time of an ion or qubit herein may be about 10 ms to about 5,000 ms. In some cases, a coherence time of an ion or qubit herein may be about 10 ms to about 50 ms, about 10 ms to about 100 ms, about 10 ms to about 500 ms, about 10 ms to about 1,000 ms, about 10 ms to about 1,500 ms, about 10 ms to about 2,000 ms, about 10 ms to about 2,500 ms, about 10 ms to about 3,000 ms, about 10 ms to about 3,500 ms, about 10 ms to about 4,000 ms, about 10 ms to about 5,000 ms, about 50 ms to about 100 ms, about 50 ms to about 500 ms, about 50 ms to about 1,000 ms, about 50 ms to about 1,500 ms, about 50 ms to about 2,000 ms, about 50 ms to about 2,500 ms, about 50 ms to about 3,000 ms, about 50 ms to about 3,500 ms, about 50 ms to about 4,000 ms, about 50 ms to about 5,000 ms, about 100 ms to about 500 ms, about 100 ms to about 1,000 ms, about 100 ms to about 1,500 ms, about 100 ms to about 2,000 ms, about 100 ms to about 2,500 ms, about 100 ms to about 3,000 ms, about 100 ms to about 3,500 ms, about 100 ms to about 4,000 ms, about 100 ms to about 5,000 ms, about 500 ms to about 1,000 ms, about 500 ms to about 1,500 ms, about 500 ms to about 2,000 ms, about 500 ms to about 2,500 ms, about 500 ms to about 3,000 ms, about 500 ms to about 3,500 ms, about 500 ms to about 4,000 ms, about 500 ms to about 5,000 ms, about 1,000 ms to about 1,500 ms, about 1,000 ms to about 2,000 ms, about 1,000 ms to about 2,500 ms, about 1,000 ms to about 3,000 ms, about 1,000 ms to about 3,500 ms, about 1,000 ms to about 4,000 ms, about 1,000 ms to about 5,000 ms, about 1,500 ms to about 2,000 ms, about 1,500 ms to about 2,500 ms, about 1,500 ms to about 3,000 ms, about 1,500 ms to about 3,500 ms, about 1,500 ms to about 4,000 ms, about 1,500 ms to about 5,000 ms, about 2,000 ms to about 2,500 ms, about 2,000 ms to about 3,000 ms, about 2,000 ms to about 3,500 ms, about 2,000 ms to about 4,000 ms, about 2,000 ms to about 5,000 ms, about 2,500 ms to about 3,000 ms, about 2,500 ms to about 3,500 ms, about 2,500 ms to about 4,000 ms, about 2,500 ms to about 5,000 ms, about 3,000 ms to about 3,500 ms, about 3,000 ms to about 4,000 ms, about 3,000 ms to about 5,000 ms, about 3,500 ms to about 4,000 ms, about 3,500 ms to about 5,000 ms, or about 4,000 ms to about 5,000 ms.

### Ion Transport Metrics

### Transport Infidelity

In some cases, ion transport in a trapped-ion quantum computer may be described by transport infidelity. Transport infidelity may describe the probability of an ion being successfully transported from one module to another. In some cases, an unsuccessful ion transport comprises loss of an ion. For example, an ion may collide with background gas molecules, resulting in ion loss. A transport infidelity of 10−2 may indicate that in 100 transport attempts only one will fail. In some cases, a transport infidelity herein may be less than about 10⁻⁸, 10⁻⁷, 10⁻⁶, 10⁻⁵, 10⁻⁴, 10⁻³, or 10⁻².

### Temperature Gain

In some cases, ion transport in a trapped-ion quantum computer may be described by a temperature gain. In some cases, a temperature may be used to provide an aggregate measure from one or more measurements of one or more ions of energy gained during ion transport. For example, temperature may provide a proxy statistic for kinetic energy gained by an ion as a result of transport. In some cases, temperature may be determined by a plurality of measurements of one ion. Temperature gain may describe how much energy the ion has gained during transport. In some cases, a temperature gain may comprise or be represented by a unit of motional quanta, mK, or eV. In some cases, a temperature gain may comprise an indication of the amount of kinetic energy that was imparted onto one or more ions during ion transport. In some cases, kinetic energy may be measured in eV. In some cases, temperature gain above a threshold may be used as a basis for commencement of maintenance, recalibration, replacement, or repair of one or more module of a trapped-ion quantum computer. In some cases, maintenance, recalibration, or repair may introduce time costs to cool ions down. As such, the techniques disclosed herein may provide particular utility by lowering temperature gain, facilitating maintenance, recalibration, replacement, or repair during computation, or both.

In some cases, the transport of an ion across an inter-module gap may comprise a temperature increase of less than about 1, 10, 100, 1,000, 10,000, 100,000, 1,000,000, or less motional quanta. In some cases, a motional quanta may be associated with a motional excitation of ions. In some cases, the transport of an ion across an inter-module gap may comprise a temperature increase of less than about 50 mK, 60 mK, 70 mK, 80 mK, 90 mK, 100 mK, 110 mK, 120 mK, 130 mK, 140 mK, 150 mK, 160 mK, 170 mK, 180 mK, 190 mK, 200 mK, or less. In some cases, the transport of an ion across an inter-module gap may comprise a kinetic energy increase of the ion of less than about 1 meV, 2 meV, 3 meV, 4 meV, 5 meV, 6, meV, 7 meV, 8 meV, 9 meV, 10 meV, 20 meV, 30 meV, 40 meV, 50 meV, 60, meV, 70 meV, 80 meV, 90 meV, 100 meV, 1 eV, or less.

In some cases, a temperature gain may be measured using a sensor. In some cases, the sensor may be used to measure a sideband absorption spectrum of an ion. In some cases, optical imaging may be used to determine a temperature gain of an ion. In some cases, the sensor may be configured to measure a fluorescence of the ion following illumination of the ion.

### Transfer Rate

In some cases, ion transport in a trapped-ion quantum computer may be described by a transfer rate. Transfer rate may describe how quickly ions are transferred between modules. In some cases, inter-module transfer rate may be at least about 182 Hz, at least about 1,000 Hz, at least about 1,500 Hz, at least about 2,000 Hz, at least about 2,500 Hz, or greater. In some cases, a transfer rate may indicate a rate of ion transport that may retain a particular transport infidelity. For example, in some cases, a transfer rate of at least about 182 Hz, at least about 1,000 Hz, at least about 1,500 Hz, at least about 2,000 Hz, or at least about 2,500 Hz, may comprise a transport infidelity of less than about 10⁻⁸, 10⁻⁷, 10⁻⁶, 10⁻⁵, 10⁻⁴, 10⁻³, or 10⁻².

### Coherent Infidelity

In some cases, ion transport in a trapped-ion quantum computer may be described by a coherent infidelity. Coherent infidelity may describe the probability that a successful ion transport (e.g., no ion loss) results in a coherent or decoherent error. In some cases, this could result in a phase error on the qubit, a spin offset of the qubit, dephasing of the qubit, or a spin flip of the qubit. In some cases, a coherent infidelity herein may be less than about 10⁻⁵, 10⁻⁴, 10⁻³, 10⁻², or 10⁻¹. In some cases, a coherent infidelity may be referred to as a decoherent infidelity.

### Additional Ion Transport Metrics

In some cases, ion transport in a trapped-ion quantum computer comprises a duration of ion transport. In some cases, an ion may be transported in about 300 μs to about 600 μs. In some cases, an ion may be transported in about 300 μs to about 500 μs. In some cases, an ion may be transported in about 300 μs to about 400 μs. In some cases, an ion may be transported in about 400 μs to about 600 μs. In some cases, an ion may be transported in about 400 μs to about 500 μs. In some cases, an ion may be transported in about 500 μs to about 600 μs.

In some cases, a distance travelled by an ion during an ion transport in a trapped-ion quantum computer may be about 400 μm to about 800 μm. In some cases, a distance travelled by an ion during an ion transport in a trapped-ion quantum computer may be about 400 μm to about 500 μm, about 400 μm to about 600 μm, about 400 μm to about 700 μm, about 400 μm to about 800 μm, about 500 μm to about 600 μm, about 500 μm to about 700 μm, about 500 μm to about 800 μm, about 600 μm to about 700 μm, about 600 μm to about 800 μm, or about 700 μm to about 800 μm.

### Illustrative Transport Path Features

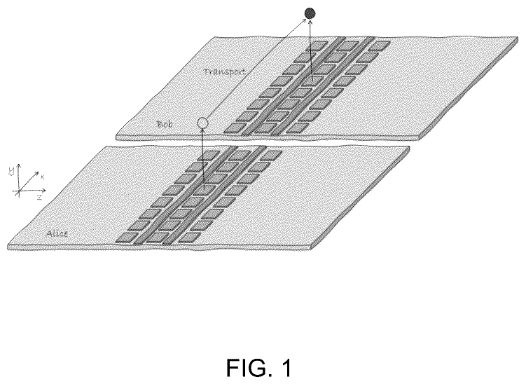

Disclosed herein are techniques for transporting ions among modules of a trapped-ion quantum computer with low temperature gain. Typically, an ion may be transported along an axial direction of a first quantum computing module and shuttled or thrown over an inter-module gap. The ion may be received at a second quantum computing module and optionally transported along an axial direction of the second quantum computing module. This transport is illustrated in FIG. 1, where the ion is transported from a first quantum computing module (Alice) to a second quantum computing module (Bob). “Hot” ions received at the second quantum computing module with a large temperature gain (e.g., over 10, 100, 1,000 motional quanta) may not be conducive to performing computations. For example, logical gates performed with more than one ion, or qubit, may have increased fidelity when performed with ground-state cooled ions. In some cases, cooling hot ions may decrease an efficiency of a quantum computer. In some cases, efficiency may refer to time to complete a computation or an ability to complete a computation. Further, sufficient addition of kinetic energy to the ion may result in the ion achieving energy enough to escape the ion trap, resulting in loss of the ion. As such, ion cooling operations may be performed on hot ions to prevent ion loss or loss of ion coherence.

Herein, techniques for mitigating temperature gain and, in addition or alternatively, for cooling ions are described. In some cases, a quantum computer herein may be modular such that a portion of the quantum computer may undergo ion cooling while another portion performs a computation. This may provide particular utility by decreasing computer downtime during module recalibration (e.g., ion cooling), maintenance, replacement, or repair. The ability to perform such recalibrations, maintenance, replacements, or repairs during operation of the quantum computer may facilitate the computation of more complex problems requiring longer computation times. In some cases, computations on a quantum computer may be performed over the course of months. As such, techniques that facilitate long-term operation of trapped-ion quantum computers may be desired. The following techniques may be applied to one or both of shuttling or throw-and-catch mechanisms. In some cases, the following techniques may be applied to quantum computer implementing a pseudopotential switch as disclosed herein.

### Waveform Augmentation

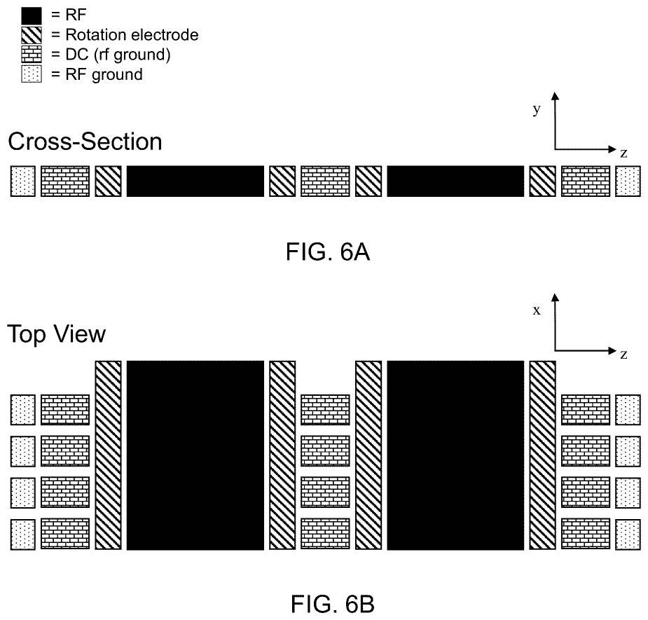

Disclosed herein are techniques for waveform augmentation. In some cases, an AC radiofrequency (RF) signal may be applied to one or more RF electrodes to confine an ion in a radial direction. During transport of the ion, a waveform may be applied to RF ground electrodes that may be segmented to facilitate transport of the ion along an axial direction (e.g., as shown in FIG. 1, ‘x’ direction of FIG. 6B). Such application of a voltage waveform may be used to push the ion along the direction of desired ion transport. Generally, the direction of desired ion transport may be an axial direction. In some cases, one or more digital-to-analog converter (DAC) may be used to generate the voltage waveform. In some cases, a controller comprising one or more of an ASIC, a CPU, a GPU, or an FPGA may control the DAC. However, the transport of the ion in this manner may introduce temperature gains to the ion. Herein, techniques for updating the voltage waveform based on a temperature gain are disclosed.

To update the voltage waveform a measure of temperature gain may be obtained. In some cases, temperature gain may be obtained via a sideband probe of the ion. A side band probe may comprise cooling the ion and measuring the populations of the blue and red motional sidebands to extract a temperature. In some cases, a temperature gain may be obtained via a Rabi flop operation. In some cases, electromagnetic energy may induce Rabi flopping on a motional sideband of a state of an ion. In some cases, temperature extraction may comprise fitting the motional sideband to a distribution. In some cases, a temperature gain may be measured using Doppler re-cooling. In Doppler re-cooling, a time an ion takes to return to the Doppler limit is measured and converted to a temperature gain. Doppler re-cooling may be based on a change in light scattering of the ion as the ion is detuned by a laser. During Doppler re-cooling, the ion may scatter light differently as the ion is detuned from the laser due to Doppler shifting. In some cases, Doppler re-cooling may comprise sub-Doppler re-cooling. In some cases, a Doppler re-cooling signal comprises applying electromagnetic energy to the ion and measuring a time for a Doppler shift of the ion to return to a Doppler limited profile. In some cases, a temperature of one or more ions may be measured using sideband spectroscopy.

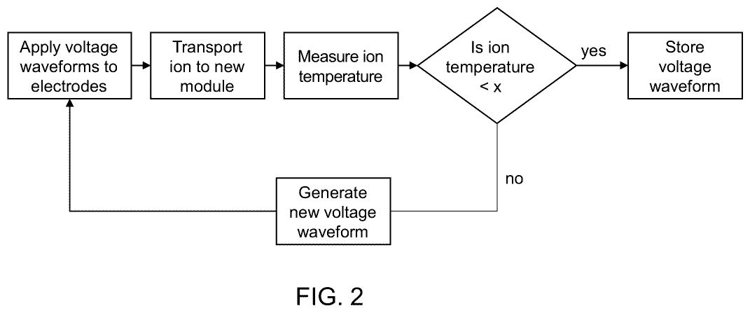

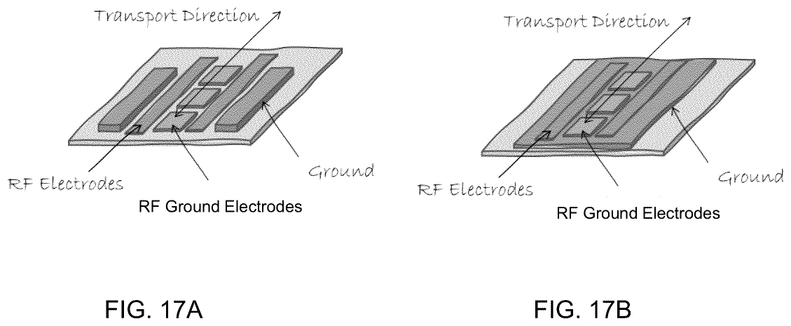

In some cases, a measured temperature gain may be used as a feedback value to augment a voltage waveform used to transport an ion. A voltage waveform herein may comprise a time- varying voltage applied to segmented RF ground electrodes (e.g., as shown in the ‘x’ direction of FIG. 6B, the transport direction of FIG. 17A). Time varying voltage waveforms may shift a location of a minimum potential energy along the axial direction or a quantum computing module, thereby shifting the ion. For example, the ion may be shifted, or transported, towards or across an inter-module gap as a function of the time varying voltage waveforms. In some cases, as shown in FIG. 2, a method using temperature gain as a feedback value may comprise operations including (i) applying a voltage waveform to an electrode, (ii) transporting an ion to a second module, (iii) measuring ion temperature, (iv) evaluating a temperature gain based on the measured ion temperature versus a threshold, and (v) generating a new voltage waveform if the temperature gain is above a threshold or storing the voltage waveform if the temperature gain is below the threshold value.

In some cases, a method for ion transport in a trapped-ion quantum computer may comprise transporting an ion across an inter-module gap using a voltage waveform, measuring a temperature of the transported ion, and updating the voltage waveform based on the temperature of the ion. In some cases, updating the voltage waveform may be used to update a trajectory of an ion during transport. In some cases, the trajectory of the ion may correlate to a temperature gain of the ion or kinetic energy imparted on the ion. In some cases, updating the voltage waveform may be performed during a computation of the trapped-ion quantum computer. For example, a portion of the modules of a trapped-ion quantum computer may be recalibrated according to a temperature gain without pausing a computation performed on another portion of the modules of the quantum computer. In some cases, the voltage waveform may be determined during an assembly or initial calibration of a trapped-ion quantum computer. In some cases, the voltage waveform may be updated to provide a transport path comprising one or both of a maximum barrier height of 10 meV or a barrier gradient of less than about 1 meV per micron. Barrier height or gradient may be determined by one or more measurements performed in the quantum computer or a simulation of the quantum computer. For example, a simulation may be performed based on operating parameters of the quantum computer to determine a barrier height or gradient. In some cases, the voltage waveform may be updated based on a machine learning prediction or gradient descent calculation. In some embodiments, a threshold condition for updating the voltage waveform may comprise finding that the temperature of the ion may be approaching or may be less than a Doppler limit.

In some cases, the feedback may be exploited by a user. For example, a user may manually change a voltage waveform parameter of a device providing the applied voltage to the segmented RF ground electrodes. In some cases, the voltage waveform parameter may comprise an amplitude or frequency of the voltage waveform. Additionally, or alternatively, a machine learning or gradient descent algorithm may be implemented to update the voltage waveform. For example, a machine learning model may be trained on one or both of simulated or experimental ion transport data. In some cases, the machine learning model may be employed to predict a most likely voltage waveform to mitigate temperature gain. This may be performed during calibration or during operation of the quantum computer. In some cases, the machine learning model may be informed by other operating conditions of the quantum computer. In some cases, the machine learning model may be used to decrease a proxy value such as potential barrier height or potential barrier gradient as opposed to the temperature gain directly. In some cases, the machine learning model may be implemented in a reinforcement or active learning framework. For example, the temperature gain of the ion may be used as a form of feedback that may be used to gather training data during operation of the quantum computer. This training data may be used to train the machine learning model iteratively over time.

### Path Choice Augmentation

In some cases, the transport path for the ion may be augmented according to a desired pseudopotential barrier or barrier gradient. In some cases, a pseudopotential barrier along an ion transport path may be less than about 10 meV. In some cases, a pseudopotential gradient along an ion transport path may be less than about 1 meV per micron. Generally, such a pseudopotential barrier, pseudopotential gradient, or both may be preferred to mitigate temperature gain of an ion during transport across an inter-module gap.

In some cases, an ion path may be configured according to a simulation of ion transport. For example, a user may implement finite element methods, general field solvers, or analytical equations to analyse an ion transport path. In some cases, analysing an ion path may comprise determining one or more parameters of a pseudopotential field along an ion path. In some cases, the user may implement a multi-scale, time-dependent, multi-physics, or any combination thereof simulation or model to analyse ion transport. Generally, a simulation may comprise a modelling of ion transport along a pseudopotential path and across an inter-module gap. As such, parameters describing the ion path may be readily discernible from calculations performed during the simulation of ion transport. For example, a simulation may reveal the topography of the pseudopotential path and any associated substantial pseudopotential barriers (e.g., >10 meV) or gradients (e.g., >1 meV per micron). As such, simulated ion transports and the associated input voltage waveforms used during the simulation may form the basis of techniques to augment later input voltage waveforms to reduce pseudopotential barriers, pseudopotential gradients, or temperature gain. In some cases, human analysis may be performed to generate the later used waveforms. In some cases, machine learning may be used to generate the later used waveforms. In some cases, gradient descent may be used to generate the later used waveforms. The selection of an updated waveform for use in a quantum computer as described herein may be performed prior to assembling the quantum computer, during calibration of the quantum computer, or during operation of the quantum computer. Waveform augmentation during operation of the quantum computer may be a result of shifts in the alignment of quantum computing modules over time (e.g., due to some maintenance, heating, module replacement, etc.). As such, the voltage waveform updating, or ion transport path augmentation techniques disclosed herein, may provide particular utility by facilitating longer computations that may be performed during recalibration, maintenance, or repair. In some cases, ion temperature gain may be used as a metric by which to optimize voltage waveforms. For example, candidate waveforms as output by a machine learning model, simulation, or user may be applied to the quantum computer to mitigate ion temperature gain or ion loss.

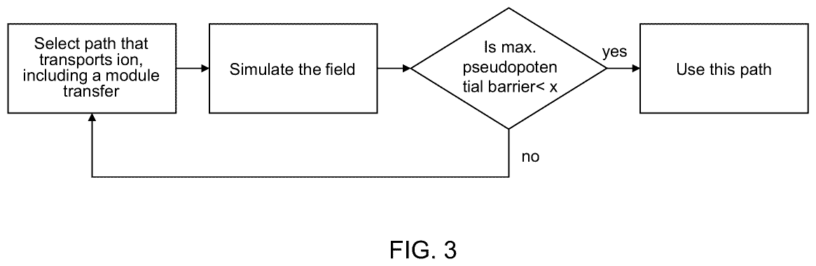

In some cases, a method may first select a candidate path between two points (e.g., across an inter-module gap). In some cases, an initial path may be selected randomly, by a machine learning model, or by a subject matter expert. A simulation tool may then be implemented to simulate the pseudopotential field along the candidate path. The simulation tool may implement finite element methods (FEM), general field solvers or analytical equations. The method may be used to determine a field profile along the candidate path. In some cases, as shown in FIG. 3, a method for updating a voltage waveform herein may comprise operations including (i) selecting an ion path that transports an ion from a first module to a second module, (ii) simulating or measuring a field, (iii) comparing a pseudopotential barrier or gradient value against a threshold value, and (iv) if the barrier or gradient value is above the threshold, updating the voltage waveform, otherwise using the path (e.g., the voltage waveform) during operation of a quantum computer. In some cases, the threshold value may be based on a kinetic energy of the ion. In some cases, the threshold value may be based on a trapped depth of the ion. For example, a threshold condition may comprise finding that the kinetic energy of the ion is less than a trap depth.

In some cases, a method for ion transport in a trapped-ion quantum computer may comprise transporting an ion across an inter-module gap using a voltage waveform, measuring a pseudopotential barrier or gradient, and updating the voltage waveform based on the pseudopotential barrier or gradient. In some cases, updating the voltage waveform may be performed during a computation of the trapped-ion quantum computer. For example, a portion of the modules of a trapped-ion quantum computer may be recalibrated according to the barrier or gradient without pausing a computation performed on another portion of the modules of the computer. In some cases, the voltage waveform may be determined during an assembly or initial calibration of a trapped-ion quantum computer. In some cases, the voltage waveform may be updated to provide a transport path comprising one or both of a maximum barrier height of 10 meV or a barrier gradient of less than about 1 meV per micron. Barrier height or gradient may be determined by one or more measurements performed in the quantum computer or a simulation of the quantum computer. For example, a simulation may be performed based on operating parameters of the quantum computer to determine a barrier height or gradient. In some cases, the voltage waveform may be updated based on a machine learning prediction or gradient descent calculation.

In some cases, path choice augmentation may be applicable to one or both of shuttling or throw-and-catch mechanisms. In some cases, path choice augmentation may be applied to a trapped-ion quantum computer implementing a pseudopotential switch. In some cases, a path may preferably comprise axial ion transport with relatively low ion fluctuation in the vertical (e.g., perpendicularly away from the module) or radial (e.g., parallel to module, not in direction of ion transport) direction. In the shuttling case, the path may comprise a continuous and constant or varying pseudopotential path from one quantum computing module to another. For throw-and-catch, the path choice may include the “exit” of one quantum computing module and the “entrance” of the other. In some cases, the path choice may account for edge inhomogeneities.

### Sympathetic Cooling

In some cases, ions may be cooled after inter-module transport. However, ions holding quantum information (qubits) may not be cooled directly. In some cases, cooling a qubit directly may scramble the quantum information held by the qubit.

In some cases, the process of sympathetic cooling may be implemented without affecting the qubit information. This may facilitate scaling of quantum computers by providing ion cooling in a system with a large number of interconnected modules. In some cases, sympathetic cooling reduces the motional energy state of an ion whilst not affecting the electronic energy states of the ion. In some cases, the qubit is stored on the electronic energy state of the ion. Generally, sympathetic cooling may comprise a qubit ion and a sympathetic coolant ion. In some cases, more than one sympathetic coolant ion may be used to cool one qubit ion. In some cases, one sympathetic coolant ion may be used to cool more than one qubit ion. The qubit ion may hold the quantum information and may participate in an algorithm or computation. In some cases, a qubit ion may be used as a sympathetic coolant ion in a later cooling operation or vice versa. The coolant ion may comprise a same or different species or isotope relative to the qubit. In some cases, the coolant ion may be the same species and isotope as a qubit, but the qubit may be shelved prior to cooling. Shelving the qubit prior to cooling may comprise a technique to map the qubit state to a different internal state, unaffected by cooling transitions.

A sympathetic cooling as disclosed herein may comprise operations including (i) transferring one or both of a qubit ion or a sympathetic coolant ion across an inter-module gap, (ii) merging or contacting at least one qubit ion with at least one sympathetic coolant ion in the same potential well, (iii) and cooling the sympathetic coolant ion, thereby cooling the qubit ion via coulombic interaction with the sympathetic coolant ion. In some cases, the cooling technique used to cool the sympathetic coolant ion may comprise Doppler cooling, sideband cooling, electromagnetically induced transparency cooling, or any combination thereof.

### Inter-Module Phase Correction

The transportation of ions among modules and across inter-module gaps may result in phase accumulation in the transferred ion. Phase accumulation may be particularly problematic for qubit ions. For qubit ions, this phase accumulation may reduce qubit coherence or information retention. In some cases, phase accumulation may be due to exposure of qubits to time-varying magnetic fields or static magnetic field inhomogeneities during transport. Generally, regardless of active or passive measures to reduce phase accumulation, some degree of phase accumulation may be expected during ion transport between modules.

Using techniques disclosed herein, phase accumulation may be measured, and the measurements ultimately stored or accounted for. In some cases, a magnetic field may be static over time and phase accumulation may be constant. As such, a degree of phase accumulation may be linked to an ion transport path. A path-associated, constant phase accumulation may be tracked through an algorithm compiler and compensated or corrected for algorithmically or via gating operations.

In some cases, phase accumulation may be measured using a coherent process. Generally, measuring phase accumulation may be performed using a form of state tomography. In state tomography, an electro-magnetic field is applied to the qubit and afterwards the state is determined. In some cases, phase accumulation measurement may be performed by fluorescence measurement. In some cases, the measurement may be repeated to obtain the phase accumulation information.

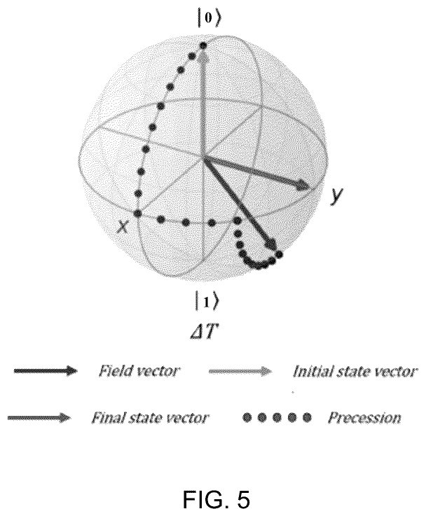

To measure phase accumulation, a qubit may be prepared in a superposition between the two qubit states (|0>and |1>). Phase may be accumulated during a set time ΔT in this state. After time ΔT, a coherent process may be used to put the qubit in a new state such that different values of phase accumulation map to different measurable states. In some cases, a first operation of a phase accumulation measurement may comprise placing the qubit in a superposition by applying a pi/2 pulse. In some cases, a second operation after time ΔT may be performed, wherein a second pi/2 pulse may be applied. The final state may depend on the phase accumulated during these operations. This process may be illustrated by the diagram depicted in FIG. 5. The state information may be extracted from the qubit by fluorescence detection. Fluorescence detection may comprise applying laser light to the ion and measuring the scattered photons. The photon scattering rate may indicate which state the qubit was in. The measurement of fluorescence scattering may be repeated many times for each value to build sufficient statistics to determine the phase accumulation of the ion. To calculate the phase associated with transport, phase accumulation measured in the manner described for a qubit that travelled a path of interest for a duration of time ΔT may be determined. The information may be stored using any standard method prior to phase correction.

### Phase Correction

The phase may be corrected by applying an additional phase component into a subsequent gate to which the qubit may be exposed. The phase may be corrected by applying an additional phase gate to the qubit after inter-module transport. By determining and tracking the phase accumulation of a qubit as a function of its transport among quantum computing modules, the phase accumulation may be corrected for in a post-processing operation. Generally, phase correction may be performed in a gate zone.

In some cases, the correction of phase accumulation in a trapped-ion quantum computer may comprise transporting a qubit over an inter-module gap from a first quantum computing module to a second quantum computing module, measuring a phase accumulation of the qubit, and applying a phase correction technique to the qubit based on the phase accumulation of the qubit. In some cases, a phase accumulation may be measured during a calibration phase, a simulation, or following inter-module ion transport. In some cases, a phase accumulation value may be measured and stored (e.g., in a classical computer system) and later applied for a phase correction. For example, a phase accumulation value may be determined for one or more qubits during operation or simulation of a trapped-ion quantum computer and stored for application to later qubits. In some cases, an amount of phase accumulation may be substantially similar among qubits transferred along a same or similar ion transport path. As such, the phase accumulation may be measured or calculated at an earlier point in time and applied to qubits at a later point in time.

In some cases, the phase correction technique may be applied prior to ion transport. For example, a transport path may comprise a pre-determined amount of phase accumulation that would be imparted on a qubit during transport. As such, a phase of the qubit may be augmented prior to transport such that transport brings the qubit to a desired phase condition. In some cases, the phase correction technique comprises exposing the ion to an electro-magnetic field. In some cases, the electro-magnetic field used for phase correction may comprise a frequency or phase difference with respect to a qubit precession frequency. In some cases, the amount of phase correction may be dependent on one or both of a phase or frequency difference of the electro- magnetic field of the phase correction technique. In some cases, the amount of phase correction may be dependent on a duration of application of the electro-magnetic field to the qubit. In some cases, the phase accumulation correction may comprise the use of a microwave field. In some cases, the phase accumulation correction may comprise the use of a laser. In some cases, the phase accumulation correction may comprise changing the magnetic field environment of the qubit. In some cases, changing the magnetic field environment of the qubit may include changing a current of an electro-magnet. In some cases, the phase accumulation correction may comprise moving the ion through a magnetic field gradient.

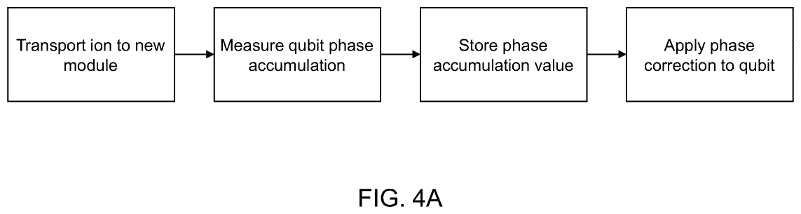

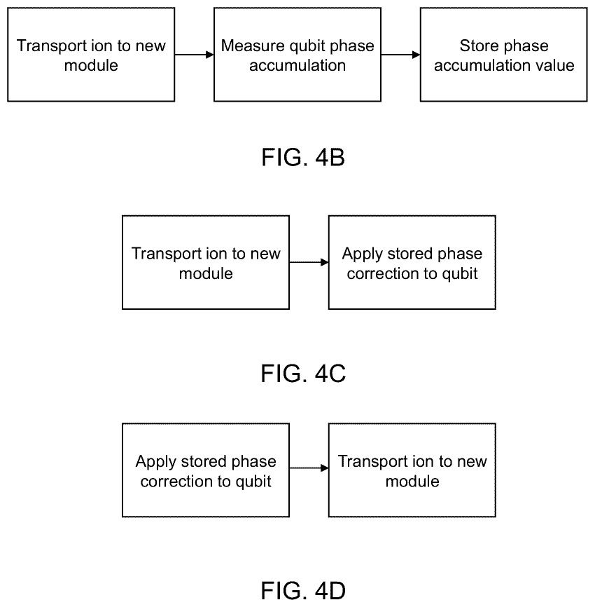

A plurality of illustrative phase accumulation correction methods are shown in FIGS. 4A-4D. FIG. 4A shows an example of ion transport, qubit phase accumulation measurement, storage of the phase accumulation measurement, and application of phase correction to a qubit. In some cases, the phase correction may be performed by a phase correction technique as disclosed herein. In some cases, the application of the phase correction may be applied to a plurality of qubits. For example, a phase accumulation along a transport path may be substantially consistent among a plurality of qubit transports along the transport path. As such, a phase accumulation measurement of an earlier qubit transport (e.g., via actual or simulated transport) may be used to inform a phase accumulation correction of a later qubit. In some cases, the amount of phase correction to apply may be retrieved from a storage device (e.g., of a classical computer system herein).

In some cases, phase accumulation may be measured and stored for a qubit as shown in FIG. 4B. Such a measurement and storage may be used to inform later phase corrections. In some cases, phase correction may be applied as shown in FIG. 4C. For example, an ion may be transferred over an inter-module gap and subsequently have a phase correction technique applied to a qubit of the ion. In some cases, phase correction may be applied as shown in FIG. 4D. For example, a phase correction technique may be proactively applied to a qubit such that phase accumulation occurring during ion transport brings a qubit phase to a desired value.

### Illustrative Structural Features

The transporting of ions across inter-module gaps in trapped-ion quantum computer may greatly facilitate both the scalability, modularity, and operating times achievable with trapped-ion quantum computers. Successful ion transport (e.g., low transport infidelity, low temperature gain) may be facilitated by alignment between or among quantum computing modules. For example, a substantially coplanar alignment as described herein may promote longer and higher fidelity inter-module gap transport. Generally, for the inter-module transport as shown in FIG. 1, physical alignment may facilitate alignment of fields used to transport the ion along a pseudopotential path.

### Edge Electrode Structure

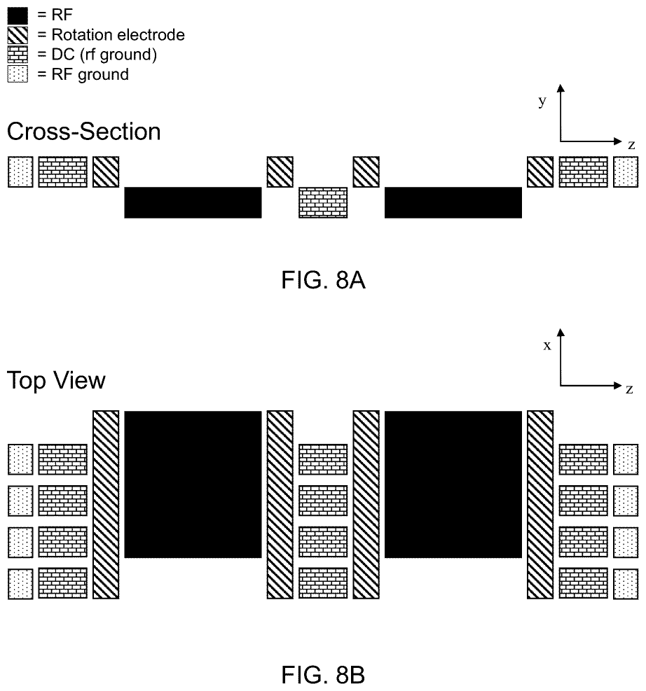

Disclosed herein are edge electrode structures that may be used to allow ions to be trapped closer to the edges of modules. The edge electrode structures disclosed may provide further utility by providing greater flexibility in manufacturing, allowing ion transport height configurability, or providing additional optimizable parameters in determinations of voltage waveforms. Illustrative edge electrode structures as disclosed herein are depicted in FIGS. 6A-B, 7A-B, and FIGS. 8A-B. For a given ion transport, there may generally be two quantum computing modules. A module may comprise of electrode structures that may be discontinuous between two modules. During transport, an ion's direction of travel may generally be considered as occurring along an ‘axial’ direction (e.g., ‘x’ in FIG. 6B). Directions perpendicular to the axial direction may generally be considered radial (e.g., ‘y’ and ‘z’ in FIG. 6A). Generally, the axial direction may be a primary direction of ion motion during a transport between two quantum computing modules.

In some cases, an oscillating field of the RF electrodes used for trapping ions in the radial directions may be discontinuous between modules. Such a discontinuity in the oscillating field may be present whether a throw-and-catch mechanism or a shuttling mechanism is implemented.

A quantum computing module herein may preferably comprise at least two RF electrodes. An RF electrode herein may carry an oscillating signal. An RF electrode herein may comprise an RF electrode. In some cases, an oscillating voltage may be applied to an RF electrode. In some cases, an RF electrode may carry a radiofrequency waveform. In some cases, there may be at least one RF ground electrode per quantum computing module. In some cases, there may be at least three RF ground electrodes per quantum computing module. Generally, RF ground electrodes may be segmented in the direction of ion transport. An RF ground electrode may be subject to a dynamically changing voltage waveform as disclosed herein. In some cases, the dynamically changing voltage may be applied to the RF ground electrodes to cause a shift in a location of a potential well containing the ion, thereby transporting the ion.

In some cases, a first RF ground electrode may be closer to a plane of a substrate than a plane comprising RF electrodes. In some cases, relative heights of a plurality of electrodes above a substrate may be selected to increase a gap between neighbouring electrodes. In some cases, a substrate may be die-bonded to a package material. In some cases, a plurality of electrodes may terminate substantially evenly at an edge of a module comprising the plurality of electrodes. In some cases, the edge may be parallel or perpendicular to a direction of ion transport. In some cases, a distance which an RF electrode extends beyond a substrate may be selected to facilitate inter-module ion transport. In some cases, a via may be disposed between an electrode of a plurality of electrodes and the substrate. In some cases, an insulator material may be disposed between two electrodes of the plurality of electrodes. In some cases, a trapped-ion quantum computing module may comprise driving circuitry. In some cases, the driving circuitry may comprise a power source. In some cases, the driving circuitry may be disposed beneath a substrate supporting the plurality of electrodes. In some cases, the driving circuity beneath the plurality of electrodes may be referred to as backside connections. Backside connections may provide particular utility by mitigating space lost to components of a quantum computing module not used directly in quantum computation or ion transport.

An illustrative edge electrode structure is shown in FIG. 6A-B. FIG. 6A shows a cross- sectional view of the edge electrode structure, while FIG. 6B shows a top-down view of the edge electrode structure. The edge electrode structure may be configured to provide a planar Paul trap. The edge electrode structures may comprise RF electrodes to provide radial ion confinement. In some cases, the edge electrode may comprise RF ground electrodes to provide axial confinement. In some cases, the application of voltage waveforms may be used to perform ion transport along the axial direction. In some cases, the RF ground electrodes may be segmented. In some cases, the RF ground electrodes may be held at RF ground. In some cases, a substantially constant voltage may be applied to an RF ground electrode. In some cases, an RF ground electrode may be used herein for ion rotation. Ion rotation may be used in cooling operations as disclosed herein. In some cases, two RF ground electrodes may be placed between two RF electrodes to facilitate ion rotation. In some cases, RF ground electrodes used for ion rotation may not be segmented. A plurality of possible edge electrode structures is depicted in FIG. 6A. In some cases, one or more RF ground electrodes may be disposed under the other electrodes of the edge electrode structure as shown in FIG. 6B.

In some cases, as shown in FIGS. 8A-B, electrodes of the edge electrode structure may not be coplanar. For example, a quantum computing module herein may comprise a plurality of planes or layers in which a portion of a plurality of electrodes may be disposed. The plurality of planes or layers may be along a ‘y’ direction as shown in FIG. 8A. In some cases, a plurality of components of an edge electrode structure may comprise an RF electrode, a RF ground electrode, or both. In some cases, an RF ground electrode herein may be used as an RF ground, to transport an ion along a direction of ion transport, to confine an ion along a direction of ion transport, to rotate an ion, or any combination thereof. In some cases, an RF ground electrode of the plurality of electrodes may be segmented. In some cases, a quantum computing module herein may comprise a first plane along a direction of ion transport and above a surface of a substrate, a second plane along the direction of ion transport and above the surface of the substrate, and a plurality of electrodes forming an ion trap. In some cases, a first portion of the plurality of electrodes may be disposed within the first plane and a second portion of the plurality of electrodes may be disposed within the second plane. In some cases, the first plane and the second plane may not be coplanar as depicted in FIG. 8A. In some cases, non-coplanar planes may comprise stacked planes. In some cases, the plurality of electrodes may be non-coplanar along planes intersecting the ‘x’ direction as shown in FIG. 8B. For example, a portion of the plurality of electrodes may extend closer to an edge of the quantum computing module than another portion of the plurality of electrodes. In some cases, a quantum computing module herein may comprise a first plane perpendicular to a direction of ion transport and parallel to an edge of a substrate, a second plane perpendicular to the direction of ion transport and parallel to an edge of a substrate, and a plurality of electrodes forming an ion trap. In some cases, a first portion of the plurality of electrodes is disposed within the first plane and a second portion of the plurality of electrodes is disposed within the second plane. In some cases, the first plane may not be coplanar with the second plane.

In some cases, a first plane axis and a second plane axis may both be along the direction of ion transport (e.g., ‘x’ direction in FIG. 8B). In some cases, the first plane axis and the second plane axis may be separated by at least about 1 nm, 10 nm, 100 nm, 1 μm, 10 μm, 100 μm, 1 mm, 10 mm, or more mm. In some cases, the first plane axis and the second plane axis may be separated in the ‘y’ direction (e.g., ‘y’ direction shown in FIG. 8A).

In some cases, an edge electrode structure herein may comprise at least three RF ground electrodes or at least two RF ground electrodes. In some cases, a separation between two electrodes of the plurality of electrodes may be at least about 1 μm, 2 μm, 3 μm, 4 μm, 5 μm, 6 μm, 7 μm, 8 μm, 9 μm, 10 μm or more μm. In some cases, a larger separation between two electrodes may provide particular utility by lowering a risk of electrical shorts between electrodes or components of a quantum computing module.

In some cases, a ratio between an RF electrode and an RF ground electrode set between two RF electrodes may be configured to modify a pseudopotential trap depth, a radial or axial secular frequency, a pseudopotential barrier, or a combination thereof. In some cases, an RF ground electrode set between two RF electrodes may be referred to as a central electrode. In some cases, ratio between an RF ground electrode and a central electrode may be at least about 0.5:1, 1:1, 1.5:1, 2:1, 2.5:1, 3:1, 3.5:1, 4:1, 4.5:1, 5:1, or more. For example, for a ratio of 3:1 may indicate an RF electrode with a width of 240 μm and an RF ground electrode (central electrode) with a width of 80 μm. In some cases, the central electrode may be partitioned into a plurality of sub-electrodes. For example, a central electrode may be partitioned to comprise rotation electrodes. To illustrate, the 80 μm central electrode of the previous example may be partitioned into three electrodes comprising a first rotation electrode, an RF ground electrode, and a second rotation electrode. In some cases, there may be gaps between the plurality of sub-electrodes. The rotation electrodes may be used to impart a rotation on an ion. In some cases, such rotation may facilitate doppler cooling. In some cases, the plurality of sub-electrodes may comprise one, two, three, four, five, or more sub-electrodes.

### Edge Electrode Protrusion

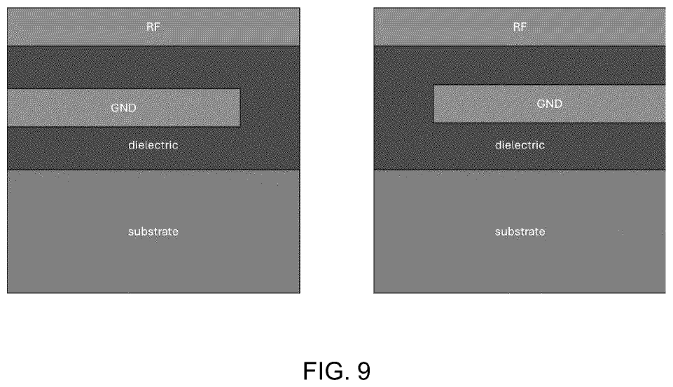

In some cases, a module as described herein may comprise a plurality of layers. In some cases, the plurality of layers may comprise a substrate, a ground plane layer, and the plurality of electrodes. A cross-sectional view of two modules comprising a plurality of layers and separated by an inter-module gap is shown in FIG. 9. In some cases, the ground plane layer may be disposed between the substrate and the plurality of electrodes. In some cases, the ground plane layer may be disposed between two layers of dielectric material. In some cases, the ground plane layer may be embedded in a dielectric material. In some cases, the ground plane layer may be recessed within the dielectric material such that the dielectric material remains flush with the plurality of electrodes (e.g., as shown in FIG. 9) or otherwise extends further towards an inter-module gap relative to the ground plane layer. In some cases, the ground plane layer may be recessed at least about 1 μm, 2 μm, 3 μm, 4 μm, 5 μm, or more within the dielectric material. In some cases, the dielectric material may be SiO₂. In some cases, the substrate may be a semi-conducting material. In some cases, the substrate may comprise Si. In some cases, the ground plane layer may comprise Al, Cu, or other metal or metal alloy. In some cases, the plurality of electrodes may comprise an RF electrode or an RF ground electrode as described herein. In some cases, the plurality of electrodes may be formed from Au, Cr, Nb, or other metal or metal alloy. For example, the plurality of electrodes may comprise electrode structures as shown in FIGS. 6A-8B.

In some cases, the plurality of electrodes may extend beyond the substrate. In some cases, the ground plane layer may extend beyond the substrate. In some cases, the ground plane layer may be embedded in a dielectric material. In some cases, the plurality of electrodes may extend beyond the substrate to a first distance and the ground plane layer may extend beyond the substrate to a second distance. In some cases, the first distance may be greater than the second distance. In some cases, the plurality of electrodes may extend at least about 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, or more beyond the substrate. In some cases, the ground plane layer may extend at least about 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, or more beyond the substrate. In some cases, the ground plane layer may extend a percentage of the distance of the plurality of electrodes beyond the substrate. For example, the ground plane layer may extend 20 μm beyond the substrate while the plurality of electrodes may extend 100 μm beyond the substrate, thus the ground plane layer extends 20% of the distance of the plurality of electrodes. In some cases, the ground plane layer may extend 10%, 20%, 30%, 40%, 50%, 60%, 70%, 80%, 90%, 91%, 92%, 93%, 94%, 95%, 96%, 97%, 98%, 99%, or 100% of the distance of the plurality of electrodes beyond the substrate. In some cases, this percentage may be configured to mitigate a pseudopotential barrier maximum along a transport path between modules.

In some cases, a module comprising a plurality of electrodes described herein may have at least a portion of the plurality of electrodes going substantially to an edge of the module. For example, an RF electrode or RF ground electrode may be terminated flush with an edge of the module. In some cases, the termination of an electrode may be the edge of the module. In some cases, the edge of the module may align with one side of an inter-module gap. In some cases, an RF electrode or RF ground electrode may be terminated about 1 μm, 2 μm, 3 μm, 4 μm, 5 μm, 6 μm, 7 μm, 8 μm, 9 μm, 10 μm from an edge of a module herein. In some cases, substantially to an edge of a module may indicate that an electrode terminates flush with or about 1 μm, 2 μm, 3 μm, 4 μm, 5 μm, 6 μm, 7 μm, 8 μm, 9 μm, 10 μm from an edge of a module herein.

In some cases, the extension of an electrode, a ground plane layer, or both, beyond a substrate may facilitate the transport of an ion across an inter-module gap. Such an extension may facilitate the generation of an ion transport path that aligns pseudopotential minima of two modules. In some cases, such alignment of pseudopotential minima may facilitate the transport of an ion to an edge of a quantum computing module without ion loss or decoherence as a function of a non-uniform pseudopotential surface that may otherwise occur at an edge of a quantum computing module.

In some cases, a ground plane layer may be substantially at a voltage ground. In some cases, the ground plane layer may be substantially at a voltage ground near an ion trap. For example, a portion of a ground plane layer may be free from routing near a region configured for trapping an ion. In some cases, substantially at a voltage ground may indicate that minor deviations from voltage ground are present in portions of the ground plane layer modified by routing. For example, a routing through or along a ground plane layer may cause a deviation from a voltage ground near the routing through or along the ground plane layer.

### Pseudopotential Switch

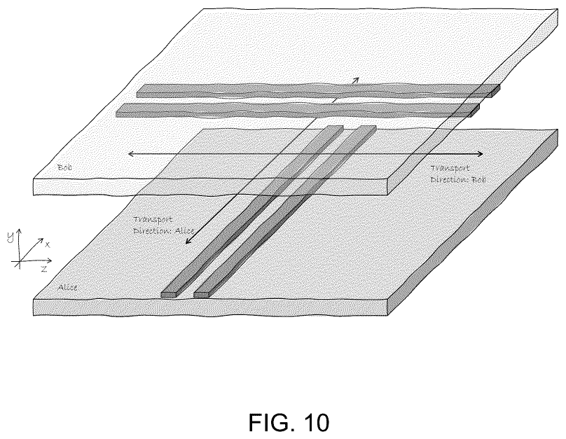

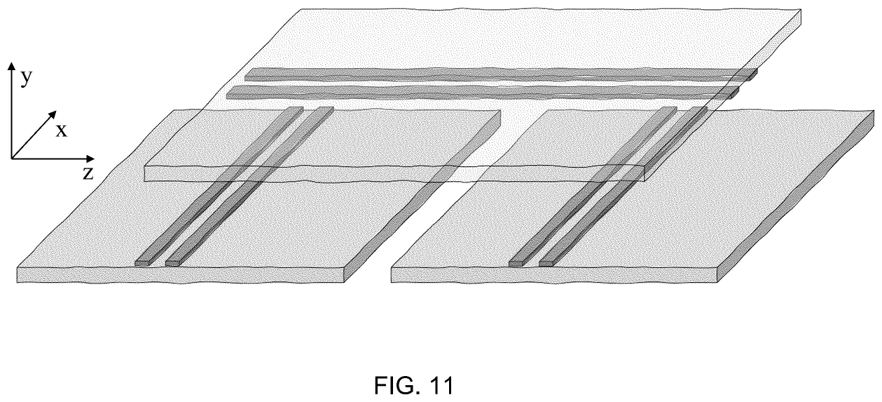

Techniques disclosed herein may be used to provide pseudopotential paths that are aligned in one, two, or three dimensions. For example, a pseudopotential path may be aligned in three directions in inter-module ion transport In some cases, an ion transport technique may comprise an alignment of a first potential well of a quantum computing module and a second potential well of a second quantum computing module. Transport based on potential well alignment as in a pseudopotential switch may provide particular utility by reducing an impact of module misalignment in one or more directions. For example, inter-module transport between two substantially coplanar quantum computing modules may be facilitated by substantial alignment in axial and radial directions (e.g., ‘x,’ ‘y,’ and ‘z’ in FIG. 8A-B). However, alignment in at least one direction of any configuration of FIGS. 10-12 may be relaxed.

Generally, ion transport between two quantum computing modules that are not substantially aligned in at least one direction involves the two modules creating overlapping pseudopotential minima. As such, an ion may be transported to the overlapping pseudopotential minima, where an RF signal in a providing module is turned off such that the ion is trapped solely in the pseudopotential minima of the receiving module. In some cases, such an ion transport may be described as a pseudopotential switch. Generally, a pseudopotential switch may be used to transport an ion between two modules with overlapping pseudopotential minima in one or more dimensions.

In some cases, an ion transport path of a first quantum computing module may be substantially perpendicular to a second ion transport path of a second quantum computing module as shown in FIG. 10. In some cases, a pseudopotential switch may be used to form a bridge among a plurality of quantum computing modules as shown in FIG. 11.

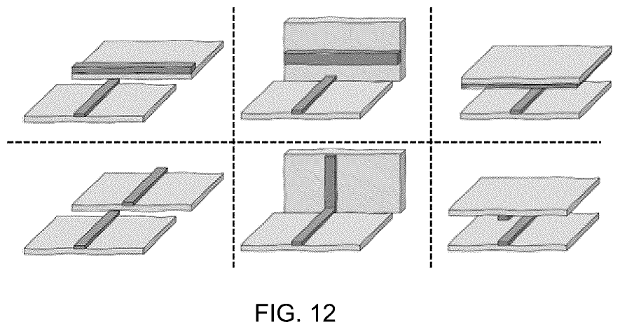

In some cases, two quantum computing modules implementing a pseudopotential switch may comprise a plurality of configurations as shown in FIG. 12. For example, two modules may be colinear and the pseudopotential directions may be colinear. In another example, two modules may be colinear and the pseudopotential directions may be perpendicular. In still another example, two modules may be perpendicular and the pseudopotential directions may be perpendicular. In still another example, two modules may be parallel and separated by about double an ion height, and the pseudopotential directions may be colinear. In a yet further example, two modules may be parallel and separated by about double an ion height, and the pseudopotential directions may not be colinear.

In some cases, a method for transferring an ion using a pseudopotential switch may comprise transporting an ion to a first pseudopotential minima of a first quantum computing module. The method may further comprise providing a second pseudopotential minima along a transport path of a second quantum computing module. In some cases, the second pseudopotential minima may be substantially aligned with the first pseudopotential minima in one or two directions. In some cases, the method may further comprise switching off the first pseudopotential minima, thereby transferring the ion from the first quantum computing module to the second quantum computing module. In some cases, the first quantum computing module and the second quantum computing module may be substantially colinear. In some cases, the first quantum computing module and the second quantum computing module may be substantially perpendicular. In some cases, the first quantum computing module and the second quantum computing module may be substantially parallel.

In some cases, a method of ion transport between two modules with pseudopotential minima substantially aligned in one or two directions may comprise switching the second quantum computing module on. For example, an ion may be transferred to a position along a transport path of a first quantum computing module that aligns with a desired position of the ion on the second quantum computing module. As such, the second quantum computing module may be turned on upon such alignment and the first quantum computing module turned off. In some cases, turning on and off may indicate the establishment or removal of a pseudopotential minimum. For example, an ion may be trapped in a pseudopotential minimum of a quantum computing module that is on.

FIGS. 10-12 show simplified, illustrative electrode structures (e.g., the dark raised features). In some cases, the simplified, illustrative electrode structures show a direction of ion transport or an ion transport path. Generally, an electrode structure used to perform ion transfers described above (e.g., in pseudopotential switches and in the descriptions of FIGS. 10-12) and elsewhere herein may comprise any combination of electrodes as described herein. For example, the simplified, illustrative electrode structures of FIGS. 10-12 may comprise electrode structures described anywhere herein (e.g., FIGS. 6A-8B, 13, 14, 15A-17B).

### Illustrative Manufacturing Features

### Backside Connections

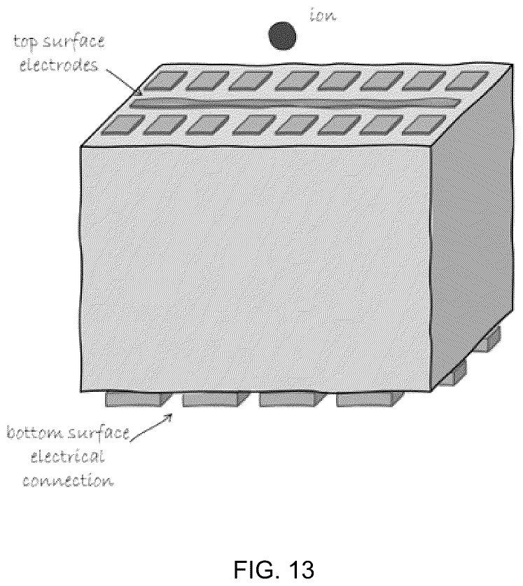

In producing trapped-ion quantum computers, surfaces of quantum computing modules may comprise electrical connections. This may fill module surface space with components not directly involved in ion transport. Further, surface electrical connections may lead to larger gaps between quantum computing modules. As such, providing electrical connections to a backside of the module may facilitate economical use of space in a trapped ion quantum computer and may decrease inter-module gaps. In some cases, backside connections to decrease inter-module gaps may provide particular utility in quantum computers implementing a shuttling ion transport mechanism. Generally, as shown in FIG. 13, a quantum computing module comprises a front side surface with electrode structures capable of trapping ions and a backside surface where electrical connections may be made. Backside connections may allow multiple modules to be tiled together on multiple sides as there may not be electrical connections creating large electrode—and therefore pseudopotential path—discontinuities at an edge of a quantum computing module.

### MCM Ion Traps

Herein, multi-chip module packaging principles may be applied to the scaling of trapped ion quantum computers. Generally, multi-chip module principles are applied in the manufacture of electronic assemblies and indicate the attachment of a plurality of discrete components to a common package material. Attachment of discrete components to a common package material provides modularity as the discrete components may be tested before inclusion in a larger system, mitigating limitations of monolithic fabrication techniques. In some cases, modules attached to a substrate may be replaced as a form of maintenance or repair without shutting down the broader system or causing wholesale re-fabrication of the system.

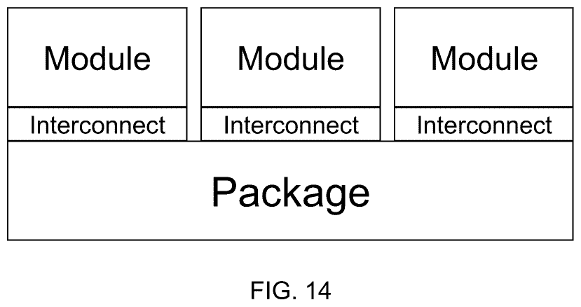

Herein, a multi-chip module packaging technique may be used to provide a system comprising a package material with multiple modules attached to the package material as shown in FIG. 14. In some cases, the module may be die-bonded to the package material. In some cases, a module die-bonded to a package material may comprise an ion trap. Such a configuration may allow for heterogenous integration of trapped-ion quantum computing modules (e.g., multiple configurations of quantum computing modules) and may improve quantum computer reliability by facilitating module pre-testing. For example, an ion trap may be fabricated, evaluated, and subsequently die-bonded to a package material rather than formed directly on the package material. Generally, using multi-chip module techniques may facilitate the formation of scalable unit cells for large-scale quantum computers. Further, the multi-chip module fabrication approach may increase trapped-ion quantum computer flexibility, scalability, manufacturability, testability, or any combination thereof. More specifically, multi-chip module fabrication provides particular advantage by providing a scalable approach to placing and aligning quantum computing modules. This advantage is of particular note where manufacturing tolerances for inter-module alignment are strict, allowing for misalignments between module edges of tens of microns or less.

In a system fabricated according to multi-chip module principles, one or more modules, ion traps, or other electrode structures may be attached to a package material through an interconnect. In some cases, The interconnect may comprise a ball grid array (BGA), a pin grid array (PGA), a land grid array (LGA), a ceramic column grid array (CCGA), a bumps array, a spring pin, or a direct bond interface. In some cases, the BGA may comprise a non-collapsible BGA. The non-collapsible BGA may comprise a core of solid material such that a degree of collapsibility of the interconnect may be limited. This may facilitate coplanarity. Generally, an interconnect may facilitate maintenance of coplanarity during manufacturing, recalibration, maintenance, replacement, or repair operations that introduce thermal expansion or pressure compression. In some cases, a quantum computing module may comprise precisely placed components (e.g., ion traps) via the use of die-bonding tools. Precision placement in quantum computing modules may provide particular utility by facilitating module alignment, module or ion trap pre-testing, or both. In some cases, a system fabricated by multi-chip module techniques may provide alignment between quantum computing modules or between quantum computing tiles with an offset of less than about 100 nm, 200 nm, 300 nm, 400 nm, 500 nm, 600 nm, 700 nm, 800 nm, 900 nm, 1 micron, 2 microns, 3 microns, 4 microns, or 5 microns. In some cases, the multi-chip module techniques may provide alignment in a vertical or lateral direction. In some cases, the multi-chip module provided alignment may refer to alignment of modules at an inter-module gap.

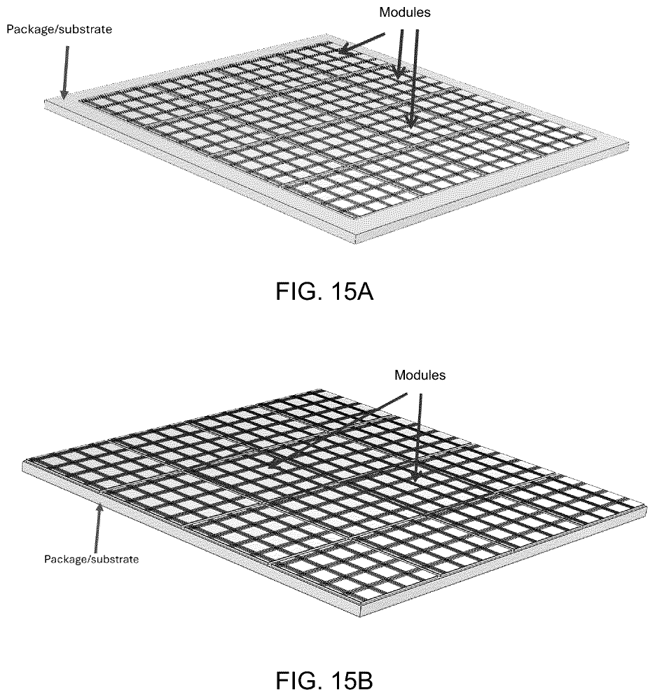

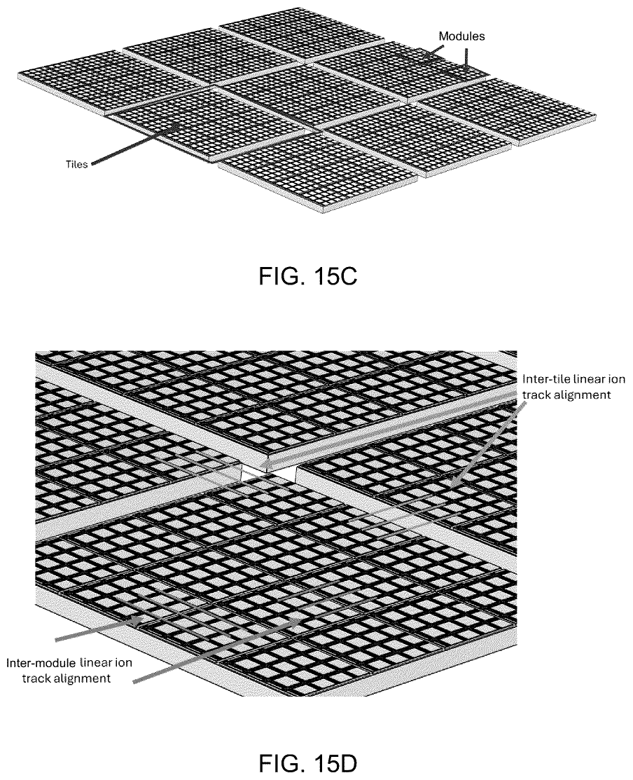

In some cases, a module bottom surface may be electrically or physically attached to the top surface of a package material. The module may be attached to the substrate with interconnect material comprising one or both single metal solders (Au, Sn, In) or multiple metal alloys (solders). In some cases, there may be more than about 10, 100, 1,000, 10,000, or more connections per package. The package material may comprise silicon, glass, ceramic, an organic semiconductor, a semiconductor wafer, or PCB materials. In some cases, a package material may be configured for wafer-to-wafer bonding or die-to-wafer bonding. For example, fabrication of a trapped ion quantum computer herein may comprise attaching a module to a package material via wafer-to-wafer or die-to-wafer bonding. In some cases, a first package material may be attached to a second package material by wafer-to-wafer bonding. The package may comprise metal interconnects to electrically connect the modules to the top or bottom surface of the package. In some cases, an adhesive material may be used in between the metal interconnects to facilitate a mechanical integrity of the attachment to the package. The package size may be larger than the total area of the plurality of modules as shown in FIG. 15A. In some cases, a package size may be the same size as the total area of the plurality of modules as shown in FIG. 15B. A bottom surface of the package may comprise at least 1, 10, 100, 1,000, 10,000, or more electrical connections that may connect to the top surface of the package and modules attached thereon. In some cases, these connections may be referred to as backside connections.

Generally, a system for quantum computing fabricated by multi-chip module techniques as disclosed herein may be used to transport an ion or encode quantum information onto an ion. For example, a top surface of a quantum computing module may comprise a linear section for transporting ions from one position to another (e.g., axial transport) and optionally a plurality of surface electrodes to encode quantum information on an ion (e.g., a qubit). In some cases, a module may only be used for transport. In some cases, the plurality of surface electrodes may comprise edge electrode structures as disclosed herein.

In some cases, a plurality of quantum computing modules may be organized into a 1D or 2D array or matrix to form a tile. Illustrative quantum computing modules and tiles are shown in FIGS. 15A-C. A tile may be arranged to align at least one surface feature of the quantum computing tiles or the modules attached thereon. For example, the modules or tiles may be aligned to align a transport path of the quantum computing modules or tiles. Generally, a module may be configured to perform a plurality of same, similar, or different quantum computing operations. Generally, a tile may comprise a plurality of same, similar, or different quantum computing modules. For example, a quantum computing module or quantum computing tile may be configured to serve a particular purpose and as such have a particular configuration. Continuing the example, a module or tile may be configured to perform ion loading, gating, transport, detection, or any combination thereof. In some cases, a module or tile may be sparsely populated. For example, a module or tile may comprise components not used in a computation or particular operation of the quantum computing system.

As shown in FIG. 15D, intra-tile or inter-tile alignment may comprise a substantially coplanar alignment as disclosed herein. Generally, gridlines or “tracks” as depicted in FIG. 15D (e.g., see arrows of FIG. 15D) may indicate a transport path as disclosed herein. Intra-tile or inter-tile alignment may comprise a substantially coplanar alignment and may comprise an offset of less than about 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, or 20 μm, in one or both of a lateral or vertical direction. Additionally, or alternatively, a substantially coplanar alignment between or within tiles may comprise a rotational offset of less than about 1 degree, 2 degrees, 3 degrees, 4 degrees, 5 degrees, 6 degrees, 7 degrees, 8 degrees, 9 degrees, 10 degrees, or less in any direction. For example, relative to the first quantum computing tile, the second quantum computing tile may be rotated about a central axis of the first quantum computing tile or module. In some cases, the central axis may correspond to a direction of ion transport. In another example, relative to the first quantum computing tile, the second quantum computing tile may be rotated about an axis perpendicular and coplanar with the central axis. In another example, relative to the first quantum computing tile, the second quantum computing tile may be rotated about an axis perpendicular and not coplanar to the central axis. In some cases, an offset may comprise a combination of rotations previously described.

As shown in FIGS. 15A-D, a quantum computing system fabricated by multi-chip module techniques may comprise a plurality of quantum computing modules attached to a package. In some cases, attachment may comprise a physical component, an electrical component, or both. In some cases, the physical component may comprise die-bonding. In some cases, the electrical component may comprise backside connections. In some cases, the organization of the plurality of quantum computing modules or tiles may be organized in a 2D array or matrix (e.g., as shown in FIGS. 15A-D) or in a 3D orientation (e.g., as shown in FIGS. 10-12). In some cases, at least two edges of two quantum computing modules may be substantially aligned. Generally, to facilitate inter-tile or intra-tile transport or ion transport across a gap, at least one linear section or transport path of two modules may be aligned as shown in FIG. 15D. In some cases, a gap or separation between a first tile and a second tile or a first module and a second module may be about 10 μm to about 150 μm. In some cases, a gap or separation between a first tile and a second tile or a first module and a second module may be less than about 10 μm, 15 μm, 20 μm, 25 μm, 30 μm, 35 μm, 40 μm, 45 μm, 50 μm, 55 μm, 60 μm, 65 μm, 70 μm, 75 μm, 80 μm,85 μm, 90 μm, 95 μm, 100 μm, 105 μm, 110 μm, 115 μm, 120 μm, 125 μm, 130 μm, 135 μm, 140 μm, 145 μm, 150 μm, or less μm.

As disclosed herein, an ion may be transported within one tile or between tiles through an electrical trap, matter-link, electric field link, or pseudopotential path across the gap formed by electrodes on the surface of the two adjacent tiles or modules.

A module herein may comprise a top surface comprising metal features and electrodes and a bottom surface attached to a package material via metal interconnects. A module may further comprise one or more layers in between for connecting the top structures to the bottom structures. In some cases, a layer of the one or more layers may comprise a plurality of electrodes. In some cases, a module may comprise a thru-via connecting the top surface to the bottom surface. In some cases, a thru-via may connect to a power source through the package material. In some cases, a module may comprise transistors or memory elements. A module may comprise or be constructed from Si, glass, SiN, GaN, GaAS, or other III-V or II-VII semiconductor compounds. In some cases, a module edge length may be about 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 25 mm, 30 mm, 35 mm, 40 mm, 45 mm, 50 mm, or more mm.

In some cases, a quantum computer fabricated by multi-chip module techniques may comprise at least two ion traps. The at least two ion traps may be die-bonded to a substrate material. In some cases, the at least two ion traps may be connected by an electric field link. In some cases, an ion trap may be connected to the package via an interconnect material. In some cases, the interconnect may be configured to provide a substantially coplanar alignment. In some cases, the interconnect material may comprise a BGA, a PGA, a bumps array, a polymer spacer, a metal pillar, a metal solder, or a spring pin. In some cases, the interconnect may be partially compressible. In some cases, a module may comprise a common package material and at least two ion traps. In some cases, a module may comprise one or more surface features, wherein the one or more surface features comprises a linear section for transporting one or more ion from one position to another position, and a plurality of electrodes.

In some cases, a module may comprise one or more ion trap. In some cases, a module comprises a substrate and a plurality of electrodes configured to trap an ion. In some cases, a module comprises one or more surface features, wherein a surface feature may comprise a linear section configured for axial ion transport or a plurality of electrodes. In some cases, the plurality of electrodes may be configured to perform one or more operations as disclosed herein. In some cases, a module may comprise a plurality of modules attached to a common package material. In some cases, the plurality of modules may be aligned along their edges to form a tile (e.g., as shown in FIGS. 13A-D). In some cases, a “track” may be aligned between modules or tiles to facilitate ion transport. For example, alignment of RF electrodes of separate trapped-ion quantum computing modules may facilitate ion transport. In some cases, a tile-to-tile gap may be the same or similar to an inter-module gap as disclosed herein. In some cases, the trapped-ion quantum computing system may comprise a plurality of tiles. In some cases, a tile may comprise a plurality of modules.

### Quilt Stitching

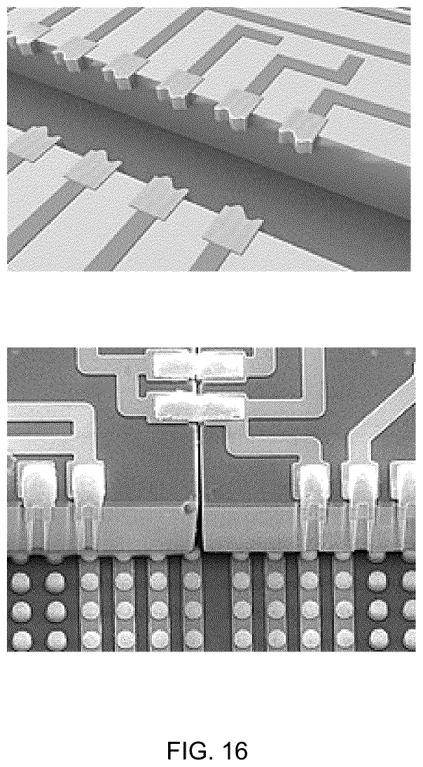

In some cases, quilt stitching may be used herein to facilitate electrical connections among modules or tiles as shown in FIG. 16. Quilt stitching may provide particular utility by facilitating a consistent trapping voltage (e.g., amplitude, frequency, phase) across modules or tiles.

Generally, quilt packaging may be applied to attach multiple ion trap modules together. Quilt stitching may comprise an integrated circuit packaging technique to provide an electrical interconnect to adjacent quantum computing modules or tiles. Quilt stitching may additionally promote physical alignment between modules or tiles. Further, the electrical connections between modules or tiles may be used to distribute the trapping RF voltage signal between modules. Generally, quilt packaging may be used to solder modules or tiles together using side-by-side connections. In some cases, quilt packaging may be used in a quantum computing system fabricated by multi-chip module techniques.

### Illustrative Quantum Computing Systems

A trapped-ion quantum computing system as disclosed herein may comprise a plurality of quantum computing modules. In some cases, a quantum computing module may comprise a plurality of electrodes configured to trap a plurality of ions. For example, RF electrodes may trap an ion in radial directions while RF ground electrodes trap an ion in an axial direction. In some cases, the trapped-ion quantum computing system may comprise or be in communication with a controller communicatively coupled to a plurality of digital-to-analog converters (DACs). The DACs may be configured to transmit an electromagnetic waveform to the plurality of electrodes. The controller may be configured to transport the ion of the plurality of ions across an inter-module gap using a voltage waveform. The voltage waveform may be applied to RF ground electrodes of the plurality of electrodes.

In some cases, the trapped-ion quantum computing system may be configured to, after transporting the ion, measure a temperature of the ion. The measured temperature may be used to update the voltage waveform based on the temperature of the ion.

In some cases, a module for a modular ion trapping system herein may comprise a substrate and a plurality of electrodes above a surface of the substrate. In some cases, the plurality of electrodes may be configured to trap one or more ions. In some cases, the plurality of electrodes may comprise at least two RF electrodes comprising an oscillating voltage. In some cases, the at least two RF electrodes may comprise RF electrodes. In some cases, the plurality of electrodes may further comprise at least three RF ground electrodes comprising a substantially constant voltage. In some cases, a first RF ground electrode of the at least three RF ground electrodes may be between the at least two RF electrodes perpendicular to the direction of transport. In some cases, a second RF ground electrode and a third RF ground electrode may be outside of the at least two RF electrodes perpendicular to the direction of transport. In some cases, the RF electrodes may carry an RF signal.

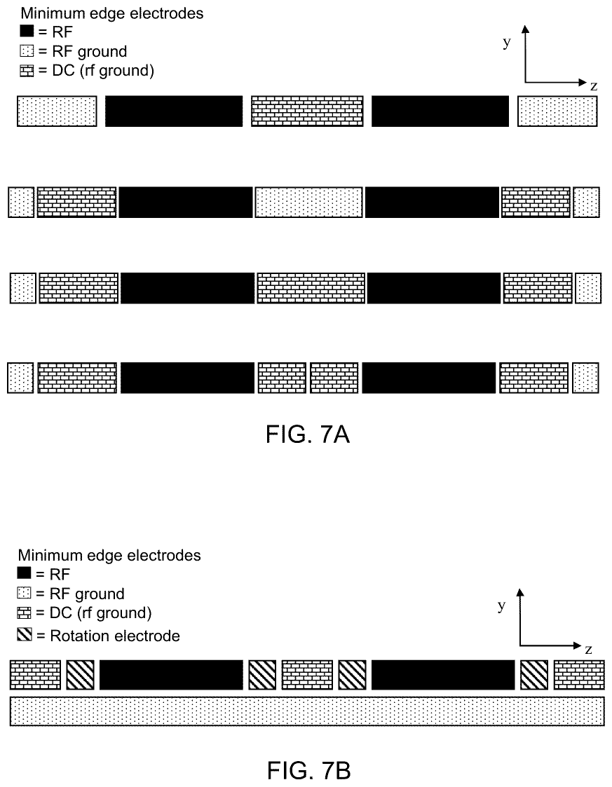

In some cases, as shown in FIGS. 7A-B and FIGS. 8A-8B, a module for a modular ion trapping system herein may comprise a substrate, a plurality of electrodes above a surface of the substrate and distributed along a direction perpendicular to a direction of transport of the one or more ions, wherein the plurality of electrodes may be configured to trap one or more ions. In some cases, the plurality of electrodes may comprise at least two RF electrodes disposed in an axis parallel to the direction of transport of the one or more ions and at least three RF ground electrodes each disposed in an axis parallel to the direction of transport of the one or more ions. In some cases, a first RF ground electrode of the at least three RF ground electrodes may be between the at least two RF electrodes. In some cases, a second RF ground electrode and a third RF ground electrode may be outside of the at least two RF electrodes.

In some cases, an oscillating voltage may be applied to the at least two RF electrodes. In some cases, a substantially constant voltage may be applied to one or more of the at least three RF ground electrodes. In some cases, the first RF ground electrode between the at least two RF electrodes may be a ground. In some cases, the first RF ground electrode between the at least two RF electrodes may be at a substantially constant voltage.

In some cases, the at least two RF electrodes may be configured to confine an ion of the one or more ions in a direction perpendicular to the direction of transport of the one or more ions. In some cases, the at least three RF ground electrodes may be configured to confine an ion of the one or more ions in the direction of transport of the one or more ions, transport the ion of the one or more ions along the direction of transport of the one or more ions, or both.

In some cases, the second and the third RF ground electrode may be grounds. In some cases, the second and the third RF ground electrode may be at a substantially constant voltage.

In some cases, the module for a modular ion trapping system may comprise a fourth or a fifth RF ground electrode further exterior to the second electrode and the third electrode. In some embodiments, the fourth or the fifth RF ground electrodes may be grounds.

In some cases, a first RF ground electrode may comprise at least two first RF ground electrodes. In some cases, at least two first RF ground electrodes may be at substantially equal voltage. In some cases, the at least two first RF ground electrodes may be at different voltages.

In some cases, the first RF ground electrode may comprise at least three first RF ground electrodes distributed along a direction perpendicular to a direction of transport of the one or more ions. In some cases, the at least three first RF ground electrodes comprise: (1) a central RF ground electrode and (2) two outer RF ground electrodes exterior to the central RF ground electrode and between the at least two RF electrodes. In some cases, the central RF ground electrode comprises a ground. In some cases, the two outer RF ground electrodes may comprise a substantially constant voltage. In some cases, a voltage of a first outer RF ground electrode may be different than a voltage of a second outer RF ground electrode. In some cases, the at least two outer RF ground electrodes may be configured to impart a rotation. In some cases, the configuration of the at least three RF ground electrodes may be similar to the configuration as shown in FIGS. 6A or 7B.

In some cases, the plurality of electrodes may lie in a plurality of planes above a surface of the substrate that may be coplanar or non-coplanar. In some cases, the non-coplanar planes may be separated by at least about 1 μm. In some cases, the non-coplanar planes may be separated by a at least about 5 μm.

In some cases, the first RF ground electrode may be closer to a plane of the substrate than a plane of the at least two RF electrodes. In some cases, the relative heights of the plurality of electrodes above the substrate may be selected to increase a gap between neighboring electrodes.

In some cases, the at least two RF electrodes may be configured to carry a radiofrequency (RF) waveform. In some cases, the direction of ion transport may approach an end of the substrate at an edge. In some cases, the plurality of electrodes may terminate substantially evenly at the edge along the direction of transport. In some cases, the at least two RF electrodes extend beyond other electrodes in the plurality of electrodes at the edge along the direction of transport. In some cases, a distance which the at least two RF electrodes extend beyond the substrate may be tuned to allow module-to-module transport. For example, the distance may be tuned to facilitate continuity in a pseudopotential barrier. In some cases, the ion may be configured to transport above the substrate and at least some of the plurality of electrodes.

In some cases, a module for a modular ion trapping system may comprise a substrate and a plurality of electrodes above a surface of the substrate and distributed along a direction perpendicular to a direction of transport of the one or more ions. In some cases, the plurality of electrodes may be configured to trap one or more ions. In some cases, the plurality of electrodes may comprise at least two RF electrodes disposed in a first axis parallel to the direction of transport of the one or more ions, a first RF ground electrode disposed between the at least two RF electrodes and in a second axis parallel to the direction of transport of the one or more ions a second RF ground electrode. In some cases, the second RF ground electrode may be disposed between the substrate and one or both of the at least two RF electrodes or the first RF ground electrode (e.g., as shown in FIG. 17B). In some cases, a third RF ground electrode may be disposed along an axis parallel to a direction of ion transport. In some cases, the second and third RF ground electrodes may be disposed outside of the two RF electrodes as shown in FIG. 17A. In some cases, a first, second, third, or any combination thereof of RF ground electrodes may comprise a ground. In some cases, a first, second, third, or any combination thereof may be segmented along a direction of ion transport.

### Additional Post Transport Operations

Disclosed herein are techniques for inter-module transport. Following inter-module transport, a plurality of operations may be performed on the transported ion. Such operations may be performed to store information, perform computations, or calibrate the trapped-ion quantum computer.

In some cases, micro-motion measurements may be performed. A micro-motion measurement may be performed with an optical measurement. In some cases, the optical measurement may comprise an image taken by a camera. In some cases, micro-motion may be used to optimize a voltage waveform as disclosed herein. In some cases, the voltage waveform may be augmented to reduce micro-motion.

In some cases, ion presence may be measured. For example, an ion presence may be measured to determine an ion transport fidelity. In some cases, an ion presence may be determined using a fluorescence measurement. In some cases, the fluorescence measurement may use a photo- multiplier tube or an avalanche photodiode.

In some cases, a qubit state may be measured. In some embodiments, qubit state may be measured to determine a coherent infidelity. Qubit state measurement may be performed using fluorescence measurements of the qubit in a readout zone of a quantum computing module.

In some cases, a phase gate may be performed. A phase gate may be used to correct a phase accumulation of the ion after transport. In some cases, a phase gate may comprise application of magnetic field to the ion. In some cases, a phase gate may be performed in a gate zone.

In some cases, a logic gate may be performed. In some cases, more than one qubit may be transported to be in a proximal location to one another for performance of a logic gate.

In some cases, an ion may be further transported to another location of the module that received the ion. For example, intra-module or intra-tile transport may be performed to transport the ion to a memory zone, loading zone, an entanglement zone, a readout zone, a detection zone, a gate zone, or any other zone described herein.

In some cases, transport may be performed for more than one ion. As such, two or more ions may be transported as a “crystal.” After transport, the two or more ions, the two or more ions may be separated. For example, the two ions may be used in a 2-qubit gate operation.

### Illustrative Quantum Computing Methods, Modules, and Systems

Clause 1: A method for cooling an ion in a trapped-ion quantum computer comprising: (a) transporting the ion over an inter-module gap from a first quantum computing module to a second quantum computing module; and (b) cooling the ion using a sympathetic cooling technique.

Clause 2: The method of clause 1, wherein the sympathetic cooling technique comprises cooling at least one coolant ion, and wherein the coolant ion coulombically interacts with the ion.

Clause 3: The method of clause 2, wherein the coolant ion coulombically interacts with one or more other ions.

Clause 4: The method of any one of clauses 1-3, wherein the sympathetic cooling technique comprises the use of two or more coolant ions.

Clause 5: The method of any one of clauses 1-4, wherein the sympathetic cooling technique comprises one or more methods selected from the group consisting of Doppler cooling, sideband cooling, wire-mediated sympathetic cooling, and electromagnetically induced transparency cooling (EIT).

Clause 6: The method of any one of clauses 1-5, wherein a coolant ion used in the sympathetic cooling technique is transported with the ion.

Clause 7: The method of any one of clauses 1-6, wherein the inter-module gap is at least about 10 μm.

Clause 8: The method of any one of clauses 1-7, wherein prior to (a) the method comprises applying a voltage waveform to a plurality of electrodes, wherein the plurality of electrodes is configured to trap a plurality of ions comprising at least the ion.

Clause 9: The method of clause 8, wherein the voltage waveform comprises an inter-module transport waveform.

Clause 10: The method of clause 9, wherein the transporting in (a) comprises applying said inter-module transport waveform to transport said ion.

Clause 11: The method to any one of clauses 1-10, wherein subsequent to (a) the method comprises measuring a temperature with a sensor.

Clause 12: The method of clause 11, wherein if the temperature is greater than a threshold (b) is performed.

Clause 13: The method of clause 11, wherein subsequent to (b) the method comprises updating said inter-module transport waveform based on said temperature.

Clause 14: The method of any one of clauses 1-13, wherein the method is performed during a computation of the trapped-ion quantum computer.

Clause 15: The method of any one of clauses 1-13, wherein the method is performed during a calibration phase of the trapped-ion quantum computer.

Clause 16: A system for cooling an ion in a trapped-ion quantum computer comprising; a plurality of quantum computing modules, wherein the plurality of quantum computing modules comprise a plurality of electrodes configured to trap a plurality of ions; and a controller communicatively coupled to a plurality of digital-to-analog converters (DACs), wherein the DACs are configured to transmit a voltage waveform to the plurality of electrodes, wherein the controller is configured to: transport an ion of the plurality of ions over an inter-module gap from a first quantum computing module to a second quantum computing module of the plurality of quantum computing modules; and cool the ion using a sympathetic cooling technique.

Clause 17: The system of clause 16, wherein the controller is a processor, an ASIC, a CPU, a GPU, or an FPGA.

Clause 18: The system of clause 16, wherein the system is configured to perform the method of any of clauses 1-15.

Clause 19: A method for ion transport in a trapped-ion quantum computer comprising: (a) transporting an ion across an inter-module gap using a voltage waveform; (b) after transporting the ion, measuring a temperature of the ion; and (c) updating the voltage waveform based on the temperature of the ion.

Clause 20: The method of clause 19, wherein (c) is performed during a computation of the trapped-ion quantum computer.

Clause 21: The method of clause 19 or clause 20, wherein (c) is performed during a calibration phase of the trapped-ion quantum computer.

Clause 22: The method of any one of clauses 19-21, wherein (c) is performed substantially without stopping a computation of the trapped-ion quantum computer or a calibration phase of the trapped-ion quantum computer.

Clause 23: The method of any one of clauses 19-22, wherein (c) is iteratively updated until a threshold condition is reached.

Clause 24: The method of clause 23, wherein the threshold condition is a number of iterations.

Clause 25: The method of clause 23, wherein the threshold condition is a maximum barrier height.

Clause 26: The method of clause 24, wherein the threshold condition is a maximum value of a gradient of a potential energy barrier across the inter-module gap.

Clause 27: The method of any one of clauses 19-26, wherein the voltage waveform is updated to provide a transport path comprising a maximum barrier height of less than about 10 meV.

Clause 28: The method of any one of clauses 19-27, wherein the voltage waveform is updated to provide a transport path comprising a potential barrier gradient of less than about 1 meV per micron.

Clause 29: The method of any one of clauses 19-28, wherein (c) is based on an output of a machine learning model.

Clause 30: The method of any one of clauses 19-29, wherein (c) is based on a gradient descent calculation.

Clause 31: The method of any one of clauses 19-30, wherein (b) comprises measuring a population of blue and red sidebands of a state of the ion in order to extract a temperature. Clause 32: The method of clause 31, wherein the sidebands are motional sidebands.

Clause 33: The method of any one of clauses 19-32, wherein (b) comprises applying electromagnetic energy to the ion to induce Rabi flopping on a motional sideband of a state of the ion.

Clause 34: The method of clause 33, wherein (b) comprises fitting the motional sideband to extract the temperature.

Clause 35: The method of any one of clauses 19-32, wherein (b) comprises measuring a Doppler recooling signal from the ion.

Clause 36: The method of clause 35, wherein the Doppler recooling signal comprises applying electromagnetic energy to the ion and measuring a time for Doppler shift of the ion to return to a Doppler limited profile.

Clause 37: The method of any one of clauses 19-36, further comprising subsequent to (c) identifying that the voltage waveform meets a threshold condition.

Clause 38: The method of clause 37, wherein the threshold condition comprises a finding that the kinetic energy of the ion is less than a trap depth.

Clause 39: The method of clauses 37, wherein the threshold condition comprises a finding that the temperature of the ion is approaching or less than a Doppler limit.

Clause 40: A system for cooling an ion in a trapped-ion quantum computer comprising; a plurality of quantum computing modules, wherein the plurality of quantum computing modules comprise a plurality of electrodes configured to trap a plurality of ions; and a controller communicatively coupled to a plurality of digital-to-analog converters (DACs), wherein the DACs are configured to transmit a voltage waveform to the plurality of electrodes, wherein the controller is configured to: transport an ion of the plurality of ions across an inter-module gap using a voltage waveform; after transporting the ion, measure a temperature of the ion; and update the voltage waveform based on the temperature of the ion.

Clause 41: The system of clause 40, wherein the controller is a processor, an ASIC, a CPU, a GPU, or an FPGA.

Clause 42: The system of clause 41 or 42, wherein the system is configured to perform the method of any of clauses 19-39.

Clause 43: A module for a modular ion trapping system comprising: a substrate; and a plurality of electrodes above a surface of the substrate and distributed along a direction perpendicular to a direction of transport of the one or more ions, wherein the plurality of electrodes are configured to trap one or more ions, wherein the plurality of electrodes comprise: at least two RF electrodes disposed in an axis parallel to the direction of transport of the one or more ions; and at least three RF ground electrodes disposed in one or more axes parallel to the direction of transport of the one or more ions, wherein a first RF ground electrode of the at least three RF ground electrodes is between the at least two RF electrodes, and wherein a second RF ground electrode and a third RF ground electrode are outside of the at least two RF electrodes.

Clause 44: The module of clause 43, wherein the second RF ground electrode and the third RF ground electrode form a single electrode disposed in a plane parallel to the surface of the substrate and below the at least two RF electrodes.

Clause 45: The module of clause 43, wherein an RF ground electrode of the at least three RF ground electrodes comprises a plurality of sub-electrodes configured to provide one or both of confinement of an ion of the one or more ions along the direction of transport of the one or more ions or transport the ion of the one or more ions along the direction of transport of the one or more ions.

Clause 46: The module of clause 45, wherein the plurality of sub-electrodes comprises at least three sub-electrodes.

Clause 47: The module of clause 43, wherein an oscillating voltage is applied to the at least two RF electrodes.

Clause 48: The module of clause 43, wherein a substantially constant voltage is applied to one or more of the at least three RF ground electrodes.

Clause 49: The module of clause 43, wherein the at least two RF electrodes are configured to confine an ion of the one or more ions in a direction perpendicular to the direction of transport of the one or more ions.

Clause 50: The module of clause 43, wherein the at least two RF electrodes provide a pseudopotential confinement of an ion of the one or more ions.

Clause 51: The module of clause 43, wherein the second and the third RF ground electrode are grounds.

Clause 52: The module of clause 43, wherein the second and the third RF ground electrode are at a substantially constant voltage.

Clause 53: The module of clause 52, further comprising a fourth and a fifth RF ground electrode further exterior to the second electrode and the third electrode.

Clause 54: The module of clause 53, wherein the fourth and the fifth RF ground electrodes are grounds.

Clause 55: The module of any one of clauses 43-54, wherein the first RF ground electrode between the at least two RF electrodes is a ground.

Clause 56: The module of any one of clauses 43-54, wherein the first RF ground electrode between the at least two RF electrodes is at a substantially constant voltage.

Clause 57: The module of clause 56, wherein the first RF ground electrode comprises at least two first RF ground electrodes.

Clause 58: The module of clause 57, wherein the at least two first RF ground electrodes are at substantially equal voltage.

Clause 60: The module of clause 57, wherein the at least two first RF ground electrodes are at different voltages.

Clause 61: The module of clause 56, wherein the first RF ground electrode comprises at least three first RF ground electrodes distributed along a direction perpendicular to a direction of transport of the one or more ions.

Clause 62: The module of clause 61, wherein the at least three first RF ground electrodes comprises: (1) a central RF ground electrode, and (2) two outer RF ground electrodes exterior to the central RF ground electrode and between the at least two RF electrodes.

Clause 63: The module of clause 62, wherein the central RF ground electrode comprises a substantially constant voltage.

Clause 64: The module of clause 62 or 63, wherein the at least two outer RF ground electrodes are configured to impart a rotation on an ion of the one or more ions.

Clause 65: The module of any one of clauses 43-64, wherein the plurality of electrodes lie in a plurality of planes above a surface of the substrate and wherein the plurality of planes are coplanar.

Clause 66: The module of any one of clauses 43-65, wherein the plurality of electrodes lie in a plurality of planes above a surface of the substrate and wherein the plurality of planes are non-coplanar.

Clause 67: The module of clause 66, wherein a first plane and a second plane of the plurality of planes are separated by at least about 1 μm.

Clause 68: The module of clause 66, wherein a first plane and a second plane of the plurality of planes are separated by at least about 5 μm.

Clause 69: The module of any one of clauses 65-68, wherein the first RF ground electrode is closer to a plane of the substrate than a plane of the at least two RF electrodes.

Clause 70: The module of any one of clauses 65-69, wherein relative heights of the plurality of electrodes above the substrate are selected to increase a gap between neighboring electrodes.

Clause 71: The module of any one of clauses 43-70, wherein the at least two RF electrodes are configured to carry a radiofrequency (RF) waveform.

Clause 72: The module of clause 71, wherein the RF waveform is configured to transport the ion along the direction of transport of the one or more ions.

Clause 73: The module of any one of clauses 43-72, wherein the direction of transport of the one or more ions approaches an end of the substrate at an edge.

Clause 74: The module of clause 73, wherein the plurality of electrodes terminates substantially evenly at the edge along the direction of transport of the one or more ions.

Clause 75: The module of clause 74, wherein the at least two RF electrodes extend beyond other electrodes in the plurality of electrodes at the edge along the direction of transport of the one or more ions.

Clause 76: The module of clause 75, wherein a distance which the at least two RF electrodes extend beyond the substrate is tuned to allow module-to-module transport.

Clause 77: The module of any one of clauses 43-76, wherein the ion is configured to transport above the substrate and at least some of the plurality of electrodes.

Clause 78: The module of any one of clauses 43-77, further comprising one or more vias between electrodes of the plurality of electrodes.

Clause 79: The module of any one of clauses 43-78, further comprising one or more insulators between electrodes of the plurality of electrodes.

Clause 80: The module of any one of clauses 43-79, further comprising driving circuitry for the plurality of electrodes.

Clause 81: The module of any one of clauses 43-80, further comprising a plurality of modules configured to allow module-to-module transport.

Clause 82: A module for a modular ion trapping system comprising: a substrate; and a plurality of electrodes above a surface of the substrate and distributed along a direction perpendicular to a direction of transport of the one or more ions, wherein the plurality of electrodes are configured to trap one or more ions, wherein the plurality of electrodes comprise: at least two RF electrodes disposed in a first axis parallel to the direction of transport of the one or more ions; a first RF ground electrode disposed between the at least two RF electrodes and in a second axis parallel to the direction of transport of the one or more ions; and a second RF ground electrode disposed between the substrate and one or both of the at least two RF electrodes or the first RF ground electrode.

Clause 83: A module for a modular ion trapping system comprising: a first plane along a direction of ion transport and above a surface of a substrate; a second plane along the direction of ion transport and above the surface of the substrate; and a plurality of electrodes forming an ion trap, wherein a first portion of the plurality of electrodes is disposed within the first plane and a second portion of the plurality of electrodes is disposed within the second plane, and wherein the first plane is not coplanar with the second plane above the surface of the substrate.

Clause 84: The module of clause 83, wherein a first plane axis and a second plane axis are both along the direction of ion transport and wherein the first plane axis and the second plane axis are separated by at least about 1 μm.

Clause 85: The module of clause 83 or 84, wherein the plurality of electrodes comprises at least two RF electrodes and at least three RF ground electrodes.

Clause 86: The module of any one of clauses 83-85, wherein a separation between two electrodes of the plurality of electrodes is at least about 5 μm.

Clause 87: The module of any one of clauses 83-86, wherein the module is the module of any one of clauses 43-82.

Clause 88: A module for a modular ion trapping system comprising: a first plane perpendicular to a direction of ion transport and parallel to an edge of a substrate; a second plane perpendicular to the direction of ion transport and parallel to the edge of the substrate; and a plurality of electrodes forming an ion trap at the edge of the substrate, wherein a first portion of the plurality of electrodes is disposed within the first plane and a second portion of the plurality of electrodes is disposed within the second plane, and wherein the first plane is not coplanar with the second plane.

Clause 89: The module of clause 88, wherein a first plane axis and a second plane axis are both perpendicular to the direction of ion transport and wherein the first plane axis and the second plane axis are separated by at least about 1 μm.

Clause 90: The module of clause 88 or clause 89, wherein the plurality of electrodes comprises at least two RF electrodes and at least three RF ground electrodes.

Clause 91: The module of any one of clauses 88-90, wherein a separation between two electrodes of the plurality of electrodes is at least about 5 μm.

Clause 92: The module of any one of clauses 88-91, wherein the module is the module of any one of clauses 43-87.

Clause 93: A system for trapped ion quantum computing, comprising: at least two modules each comprising an ion trap, wherein the at least two modules are die-bonded to a common package material, and wherein the at least two modules are connected by an electric field link.

Clause 94: The module of clause 93, wherein an interconnect material is disposed between a module of the at least two modules and the common package material.

Clause 95: The system of clause 94[0150], wherein the interconnect is configured to provide a substantially coplanar alignment.

Clause 96: The system of clause 94 or 95, wherein the interconnect comprises a BGA, a PGA, a bumps array, a polymer spacer, a metal pillar, a metal solder, or a spring pin.

Clause 97: The system of any one of clauses 93-96[0150], wherein the interconnect is partially compressible.

Clause 98: The system of any one of clauses 93-97[0150], wherein a first edge of a first ion trap is laterally offset from a second edge of a second ion trap by at most about 10 μm.

Clause 99: The system of any one of clauses 93-98, wherein a first edge of a first ion trap is vertically offset from a second edge of a second ion trap by at most about 10 μm.

Clause 100: The system of any one of clauses 93-99, wherein a coherent infidelity associated with ion transport between a first ion trap and a second ion trap is less than about 5%.

Clause 101: The system of any one of clauses 93-100, wherein a transport infidelity associated with ion transport between a first ion trap and a second ion trap is less than about 5%.

Clause 102: The system of any one of clauses 93-101, wherein the system for trapped ion quantum computing comprises a portion of a trapped ion quantum computer.

Clause 103: The system of any one of clauses 93-102, wherein a substrate of a module of the at least two modules is die-bonded to the package material.

Clause 104: The system of clause 103, wherein each ion trap comprises one or more of the following surface features: a section for transporting an ion from one position to another or a plurality of electrodes configured to trap an ion.

Clause 105: The system of clause 104, wherein the plurality of electrodes are configured to perform one or more operations on the ion within the ion trap.

Clause 106: The system of any one of clauses 93-105, wherein the common package material comprises silicon, glass, ceramic, organic semiconductor package, or a PCB material.

Clause 107: The system of any one of clauses 93-106, wherein a module of the at least two modules forms a second electric field link with a third module on a second package material.

Clause 108: The system of clause 107, wherein the module forms a third electric field link with a fourth module on a third package material.

Clause 109: The system of clause 108, wherein an edge-to-edge distance between the common package material and the second or third package material is less than 150 microns.

Clause 110: The system of any one of clauses 93-109, wherein top surfaces of adjacent modules are coplanar to within less than about 10 microns.

Clause 111: The system of any one of clauses 93-110, wherein the system is fabricated according to multi-chip module packaging principles.

Clause 112: A method for transferring an ion between a first quantum computing module and a second quantum computing module comprising: transporting an ion to a first pseudopotential minima of the first quantum computing module; providing a second pseudopotential minima at the second quantum computing module, wherein the second pseudopotential minima is substantially aligned with the first pseudopotential minima in one or two directions; and switching off the first pseudopotential minima, thereby transferring the ion from the first quantum computing module to the second quantum computing module.

Clause 113: The method of clause 112, wherein the first quantum computing module and the second quantum computing module are substantially colinear.

Clause 114: The method of clause 113[0135], wherein the first quantum computing module and the second quantum computing module are substantially perpendicular.

Clause 115: The method of clause 114[0135], wherein the first quantum computing module and the second quantum computing module are substantially parallel.

Clause 116: A method of correcting phase accumulation in a trapped-ion quantum computer comprising: (a) transporting an ion over an inter-module gap from a first quantum computing module to a second quantum computing module; (b) measuring a phase accumulation of the ion; and (c) applying a phase correction technique to the ion based on the phase accumulation of the ion.

Clause 117: The method of clause 116, wherein the ion comprises a qubit.

Clause 118: The method of clause 116 or 117, further comprising, subsequent to (b) storing the phase accumulation value.

Clause 119: The method of any one of clauses 116-118, wherein the measuring in (b) comprises a fluorescence measurement.

Clause 120: The method of any one of clauses 116-119, wherein the measuring in (b) is repeated to reach adequate measurement statistics.

Clause 121: The method of any one of clauses 116-120, wherein the phase correction technique comprises exposing the ion to an electro-magnetic field.

Clause 122: The method of clause 121, wherein the electro-magnetic field comprises a microwave field.

Clause 123: The method of clause 122, wherein the electro-magnetic field is generated by a laser.

Clause 124: The method of any one of clauses 116-123, wherein the phase correction technique comprises moving the ion through a magnetic field gradient.

Clause 125: The method of any one of clauses 116-124, wherein the electro-magnetic field in (c) is configured to change a phase of the ion.

Clause 126: The method of any one of clauses 116-125, wherein the phase correction technique comprises adding an additional phase term in a subsequent logical operation.

Clause 127: A method of correcting phase accumulation in a trapped-ion quantum computer comprising: (a) applying a phase correction technique to an ion and (b) transporting the ion over an inter-module gap from a first quantum computing module to a second quantum computing module.

Clause 128: A trapped-ion quantum computer, the trapped-ion quantum computer comprising a plurality of quantum computing modules, wherein each module of the plurality of quantum computing modules is fabricated on a substrate, wherein feature electrode structures on a module of the plurality of quantum computing modules extend at least partially to an edge of an inter-module gap, and wherein an ion is transported across the inter-module gap with a temperature increase of less than about 100 motional quanta and a transfer infidelity rate of less than about 0.01.

Clause 129: Any one of the preceding clauses, wherein the inter-module gap is greater than about 10 μm.

Clause 130: Any one of the preceding clauses, wherein two adjacent modules of said plurality of quantum computing modules comprise substantially coplanar alignment.

Clause 131: Any one of the preceding clauses, wherein the substantially coplanar alignment comprises a lateral offset of less than about 10 μm.

Clause 132: Any one of the preceding clauses, wherein the substantially coplanar alignment comprises a vertical offset of less than about 10 μm.

Clause 133: Any one of the preceding clauses, wherein a quantum computing module of said plurality of quantum computing modules comprises at least two RF electrodes and at least three RF ground electrodes.

Clause 134: Any one of the preceding clauses, wherein a first amplitude of a first RF electrode signal of a first quantum computing module of the plurality of quantum computing modules is substantially the same as that of a second amplitude of a second RF electrode signal of a second quantum computing module of the plurality of quantum computing modules.

Clause 135: Any one of the preceding clauses, wherein a difference between the first amplitude and the second amplitude is about less than about 5%

Clause 136: Any one of the preceding clauses, wherein a first phase of a first RF electrode signal of a first quantum computing module of the plurality of quantum computing modules is substantially the same as that of a second phase of a second RF electrode signal of a second quantum computing module of the plurality of quantum computing modules.

Clause 137: Any one of the preceding clauses, wherein an offset of the first phase and the second phase is less than about 5 degrees.

Clause 138: Any one of the preceding clauses, wherein the ion is a Yb ion.

Clause 139: Any one of the preceding clauses, wherein the ion is a Yb ion, a Ba ion, a Mg ion, a Ca ion, Sr ion, or a Be ion.

Clause 140: Any one of the preceding clauses, wherein the ion comprises a two-state quantum mechanical system.

Clause 141: Any one of the preceding clauses, wherein a first surface of the quantum computing module comprises the feature electrode structures and a second surface of the quantum computing module comprises electrical connections, and wherein the first and second surfaces are on opposite sides of the quantum computing module.

Clause 142: Any one of the preceding modules, wherein the module further comprises a ground plane layer.

Clause 143: The module of clause 142, wherein the ground plane layer is disposed between the substrate and the plurality of electrodes.

Clause 144: The module of clause 143, wherein the ground plane layer extends further toward an inter-module gap than the substrate.

Clause 145: The module of clause 144, wherein the plurality of electrodes extend further toward the inter-module gap than the ground plane layer.

Clause 146: The module of clause 143, wherein the substrate extends further toward the inter-module gap than the ground plane layer.

Clause 147: The module of clause 146, wherein the plurality of electrodes extend further toward the inter-module gap than the substrate.

Clause 148: The module of clause 143, wherein the ground plane layer is embedded in a dielectric material.

Clause 148: The module of clause 148, wherein the ground plane layer is recessed within the dielectric material by at least about 3 μm.

Clause 149: Any one of the preceding modules, wherein an alignment between the module and an adjacent module comprises a controlled lateral offset.

### Examples of Classical Computer Systems

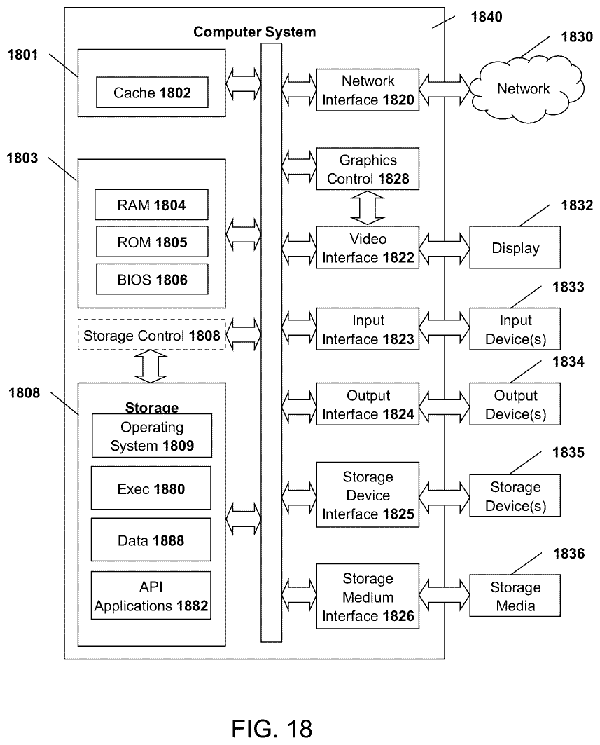

Referring to FIG. 18, a block diagram is shown depicting an example machine that includes a computer system 1800 (e.g., a processing or computing system) within which a set of instructions can execute for causing a device to perform or execute any one or more of the methods or techniques for static code scheduling of the present disclosure. The computer system 1800 provides an illustrative computer system with which a trapped-ion quantum computer herein may interact. For example, the computer system 1800 may be used to implement simulations, machine learning training or inference, gradient descent algorithms, reinforcement learning, mathematical modelling, signal generation (e.g., controlling magnetic fields), data storage (e.g., voltage waveforms), data processing (e.g., fluorescence measurements), or other operation disclosed herein that may be performed with or by a classical computer. In practice, a trapped-ion quantum computer may be in communication with one or more computer systems of a same, similar, or different configuration as computer system 1800. In some cases, the computer system 1800 may be in communication with a plurality of trapped-ion quantum computers. The components in FIG. 18 are examples and do not limit the scope of use or functionality of any hardware, software, embedded logic component, or a combination of two or more such components with particular implementations.

Computer system 1800 may include one or more processors 1801, a memory 1803, and a storage 1808 that communicate with each other, and with other components, via a bus 1840. The bus 1840 may also link a display 1832, one or more input devices 1833 (which may, for example, include a keypad, a keyboard, a mouse, a stylus, etc.), one or more output devices 1834, one or more storage devices 1835, and various tangible storage media 1836. All of these elements may interface directly or via one or more interfaces or adaptors to the bus 1840. For instance, the various tangible storage media 1836 can interface with the bus 1840 via storage medium interface 1826. Computer system 1800 may have any suitable physical form, including but not limited to one or more integrated circuits (Ics), printed circuit boards (PCBs), mobile handheld devices (such as mobile telephones or PDAs), laptop or notebook computers, distributed computer systems, computing grids, or servers.

Computer system 1800 includes one or more processors 1807 (e.g., central processing units (CPUs), general purpose graphics processing units (GPGPUs), or quantum processing units (QPUs)) that carry out functions. Processors 1801 optionally contains a cache memory unit 1802 for temporary local storage of instructions, data, or computer addresses. Processors 1801 are configured to assist in execution of computer readable instructions. Computer system 1800 may provide functionality for the components depicted in FIG. 18 as a result of the processors 1801 executing non-transitory, processor-executable instructions embodied in one or more tangible computer-readable storage media, such as memory 1803, storage 1808, storage devices 1835, or storage medium 1836. The computer-readable media may store software that implements particular operations, and processors 1801 may execute the software. Memory 1803 may read the software from one or more other computer-readable media (such as mass storage devices 1835, 1836) or from one or more other sources through a suitable interface, such as network interface 1820. The software may cause processors 1801 to carry out one or more processes or one or more operations of one or more processes described or illustrated herein. Carrying out such processes or operations may include defining data structures stored in memory 1803 and modifying the data structures as directed by the software.

The memory 1803 may include various components (e.g., machine readable media) including, but not limited to, a random access memory component (e.g., RAM 1804) (e.g., static RAM (SRAM), dynamic RAM (DRAM), ferroelectric random access memory (FRAM), phase-change random access memory (PRAM), etc.), a read-only memory component (e.g., ROM 1805), and any combinations thereof. ROM 1805 may act to communicate data and instructions unidirectionally to processors 1801, and RAM 1804 may act to communicate data and instructions bidirectionally with processors 1801. ROM 1805 and RAM 1804 may include any suitable tangible computer-readable media described below. In one example, a basic input/output system 1806 (BIOS), including basic routines that help to transfer information between elements within computer system 1800, such as during start-up, may be stored in the memory 1803.

Fixed storage 1808 is connected bidirectionally to processors 1801, optionally through storage control unit 1807. Fixed storage 1808 provides additional data storage capacity and may also include any suitable tangible computer-readable media. Storage 1808 may be used to store operating system 1809, executables 1810, data 1811, applications 1812 (application programs), and the like. Storage 1808 can also include an optical disk drive, a solid-state memory device (e.g., flash-based systems), or a combination of any of the above. Information in storage 1808 may, in appropriate cases, be incorporated as virtual memory in memory 1803.

In one example, storage devices 1835 may be removably interfaced with computer system 1800 (e.g., via an external port connector (not shown)) via a storage device interface 1825. Particularly, storage devices 1835 and an associated machine-readable medium may provide non-volatile or volatile storage of machine-readable instructions, data structures, program modules, or other data for the computer system 1800. In one example, software may reside, completely or partially, within a machine-readable medium on storage devices 1835. In another example, software may reside, completely or partially, within processors 1801.

Bus 1840 connects a wide variety of subsystems. Herein, reference to a bus may encompass one or more digital signal lines serving a common function, where appropriate. Bus 1840 may be any of several types of bus structures including, but not limited to, a memory bus, a memory controller, a peripheral bus, a local bus, and any combinations thereof, using any of a variety of bus architectures. As an example, and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 1800 may also include an input device 1833. In one example, a user of computer system 1800 may enter commands or other information into computer system 1800 via input devices 1833. Examples of an input devices 1833 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some cases, the input device is a Kinect, Leap Motion, or the like. Input devices 1833 may be interfaced to bus 1840 via any of a variety of input interfaces 1823 (e.g., input interface 1823) including, but not limited to, serial, parallel, game port, USB, FIREWIRE, THUNDERBOLT, or any combination of the above.

In some cases, when computer system 1800 is connected to network 1830, computer system 1800 may communicate with other devices, specifically mobile devices and enterprise systems, distributed computing systems, cloud storage systems, cloud computing systems, and the like, connected to network 1830. Communications to and from computer system 1800 may be sent through network interface 1820. For example, network interface 1820 may receive incoming communications (such as requests or responses from other devices) in the form of one or more packets (such as Internet Protocol (IP) packets) from network 1830, and computer system 1800 may store the incoming communications in memory 1803 for processing. Computer system 1800 may similarly store outgoing communications (such as requests or responses to other devices) in the form of one or more packets in memory 1803 and communicated to network 1830 from network interface 1820. Processors 1801 may access these communication packets stored in memory 1803 for processing.

Examples of the network interface 1820 include, but are not limited to, a network interface card, a modem, and any combination thereof. Examples of a network 1830 or network segment 1830 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 1830, may employ a wired or a wireless mode of communication. In general, any network topology may be used.

Information and data can be displayed through a display 1832. Examples of a display 1832 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 1832 can interface to the processors 1801, memory 1803, and fixed storage 1808, as well as other devices, such as input devices 1833, via the bus 1840. The display 1832 is linked to the bus 1840 via a video interface 1822, and transport of data between the display 1832 and the bus 1840 can be controlled via the graphics control 1821. In some cases, the display is a video projector. In some cases, the display is a head-mounted display (HMD) such as a VR headset. In further cases, suitable VR headsets include, by way of non- limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further cases, the display is a combination of devices such as those disclosed herein.

In addition to a display 1832, computer system 1800 may include one or more other peripheral output devices 1834 including, but not limited to, an audio speaker, a printer, a storage device, and any combinations thereof. Such peripheral output devices may be connected to the bus 1840 via an output interface 1824. Examples of an output interface 1824 include, but are not limited to, a serial port, a parallel connection, a USB port, a FIREWIRE port, a THUNDERBOLT port, and any combinations thereof.

### DEFINITIONS

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity or for ready reference, and the inclusion of such definitions herein should not necessarily be construed to represent a substantial difference over what is generally understood in the art.

As used herein, the singular forms “a,” “an,” and “the” include plural references unless the context clearly dictates otherwise. Any reference to “or” herein is intended to encompass “or” unless otherwise stated

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain inventive embodiments herein contemplate numerical ranges. When ranges are present, the ranges include the range endpoints. Additionally, every sub range and value within the range is present as if explicitly written out.

The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

### EXAMPLES

### Example 1: RF Electrode vs. RF Ground Electrode Ratio

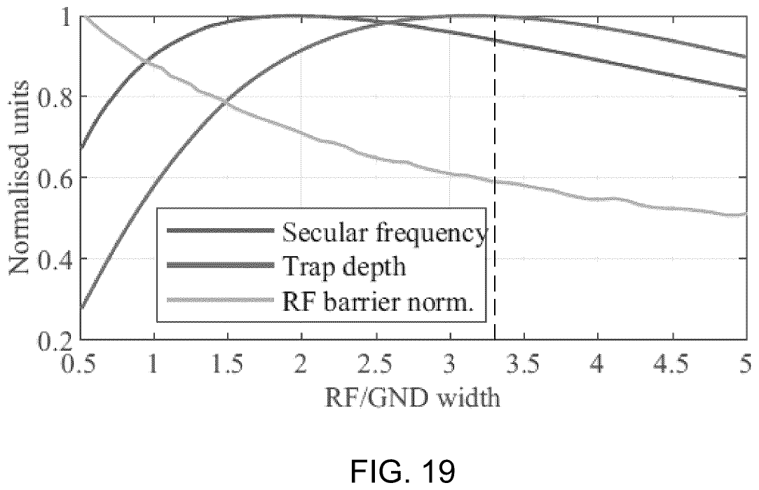

A quantum computing module as described herein can have two RF electrodes with one or more RF ground electrode contained between the two RF electrodes (e.g., as shown in FIGS. 6A-B). As shown in FIG. 19, the ratio between a width of an RF electrode of the two RF electrodes and the central RF ground electrodes can impact the relative secular frequencies, trap depths, and RF pseudopotential barrier heights of a quantum computing module. For the simulated results (COMSOL), the electrodes of the modules on opposite sides of a 10 μm inter-module gap were misaligned by 10 μm in vertical and horizontal directions. Based on the simulation, an optimal electrode configuration, based on trap depth, would have a ratio between the outer two RF electrodes and central RF ground electrodes of 3.3:1. For an ion height of 125 μm, this would indicate a central RF ground electrode with a width of 80 μm and an RF electrode with a width of 264 μm.

### Example 2: Extension of Electrodes or Ground Plane Layer Beyond Substrate

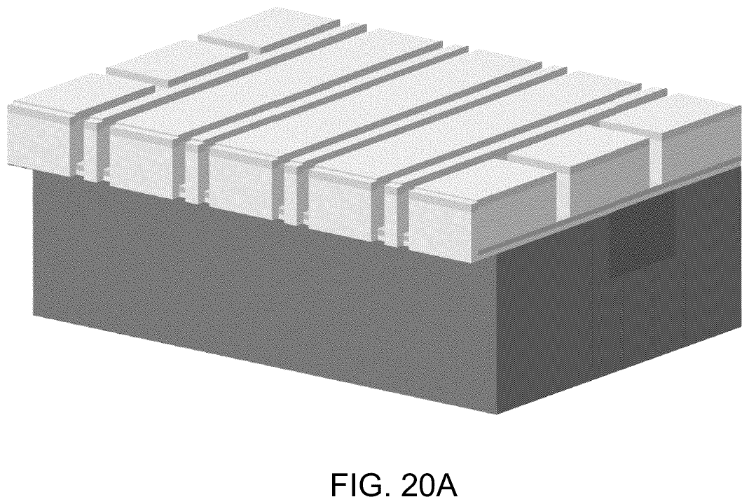

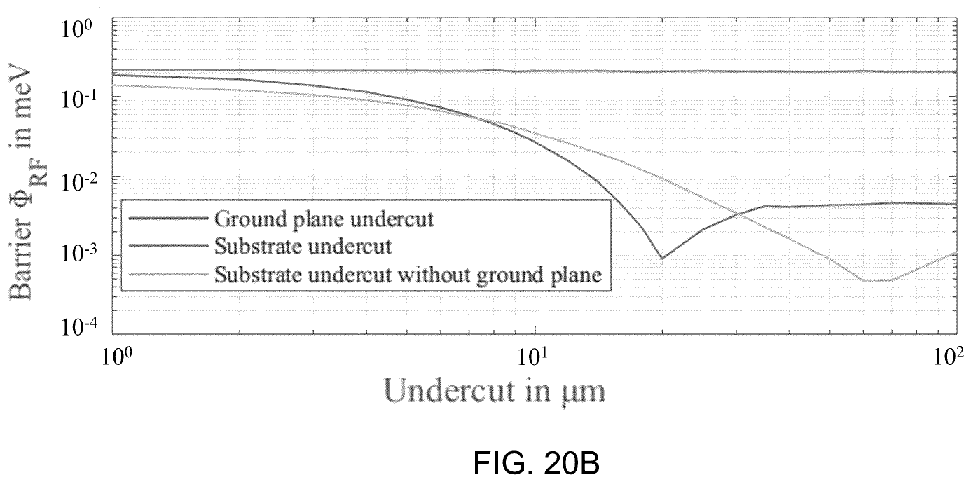

A quantum computing module herein can have one or both of a ground plane layer or electrode (or a plurality thereof) extend beyond a substrate upon which they are fabricated. An example of such extension beyond a substrate is shown in FIG. 20A. The effect of such extension (alternatively characterized by undercut in this example) is shown via simulation in FIG. 20B. Demonstrated is the effect on maximal pseudopotential barrier height as a function of undercut for several configurations with an inter-module gap of 10 μm.

The top-most, nearly horizontal curve shows the effect of undercutting only the substrate. In this case, the ground plane layer continues to be aligned with the electrodes, both extending beyond the substrate by at least 1 μm.

The curve with a vertex at about 20 μm on the x-axis shows the effect of undercutting the ground plane layer to various degrees. For this curve, the substrate is undercut by 100 μm. To clarify, at the referenced vertex point, the ground plane layer is undercut relative to the electrodes of the module by 20 μm, while the substrate is undercut relative to the electrodes by a constant 100 μm.

The final curve shows the effect on pseudopotential barrier height as a function of undercutting the substrate, where the ground plane layer is flush with or further recessed relative to the undercut substrate. These three curves show the influence of the relative alignment of, for one illustrative pair of modules, electrodes, a ground plane layer, and a substrate.

### Example 3: Intentional Module Offset

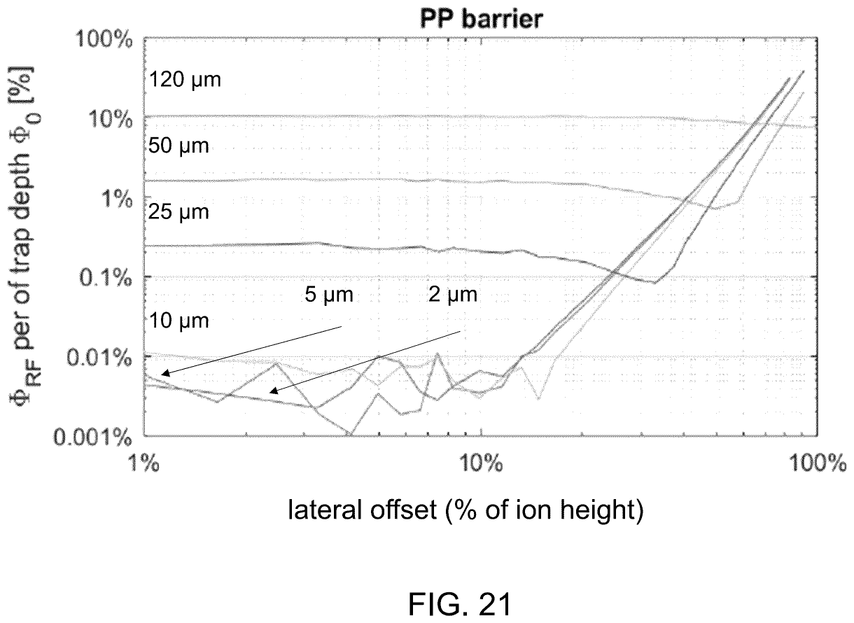

As shown in FIG. 21, an offset of the alignment between two modules may provide a decrease in a pseudopotential barrier along an ion transport path. The horizontal axis of this graph reflects a percent offset between two quantum computing modules as a function of ion height. The vertical axis of FIG. 21 shows the maximal pseudopotential barrier along the transport path as a percent of the ion trap depth. The numbers adjacent to the plotted curves relay the inter-module gap distance in μm. In this example, a lateral offset along the z-axis (e.g., of FIG. 1) was evaluated for impact on the maximal pseudopotential. As shown, a controlled lateral offset can sometimes be used to reduce the maximal pseudopotential barrier along an ion transport path.

### Example 4: Illustrative Fabrication of Ion Trap for Quantum Computing Module

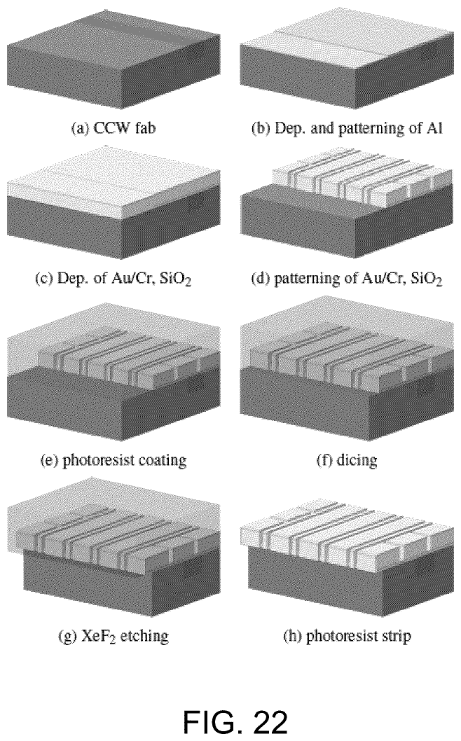

Illustrated in FIG. 22 is a process for fabricating an ion trap for use in a quantum computing module. Shown in (a) of FIG. 22 is a current carrying wire (CCW) fabrication following the damascene process. The CCW is embedded in a silicon substrate. Following (a), a 0.5 μm-thick SiO₂ layer is deposited by plasma-enhanced chemical vapor deposition (PECVD) to insulate the CCW(s) the layer is structured using wet etching. Next an ion trap ground plane layer is fabricated by depositing and wet etching a 1 μm-thick layer Al layer (as shown in (b)). An 8 μm-thick SiO₂ layer is deposited by PECVD to form a thick insulating layer between the ground plane and the subsequently sputtered 10/1000nm-thcik Cr/Au top layer (as shown in (c)). To create the electrode structures, the metal layer (Cr/Au) is lithographically patterned by ion beam, etching. Using the same photoresist, a plasma etch is used to form deep trenches in the oxide layer, using the Al ground plane layer as an etch stop (as shown in (d)). The geometry of the edge is defined by this lithography and etching step and protrudes over the ground plane by 3 μm to account for, and mitigate, any alignment errors.

The surface ion trap now undergoes post-processing to make it suitable for precise alignment. The wafer is coated with 15 μm-thick photoresist for protection during the dicing process (as shown in (e)). After dicing the wafer into individual modules, the modules are diced again, with the dicing lines as close as possible to the end of the electrodes pattern (20±10 μm in this case) using a standard diamond dicing saw and a diamond resin blade with a width of 30 μm (as shown in (f)). In this process, an XeF₂ etch time is set to aim to undercut the silicon by 20 μm to ensure that the electrode structures protrude over the substrate (as shown in (g)). The process parameters are machine and device specific. For this device, five pulses of 45 s at 2 Torr pressure were used for the XeF₂ tool (SPTS Xactix X4). Following the silicon etching step, the etched die is dipped into a photoresist remover at 70° C., thereby finishing the whole process.

### Example 5: Illustrative Modules Attached to a Package Material

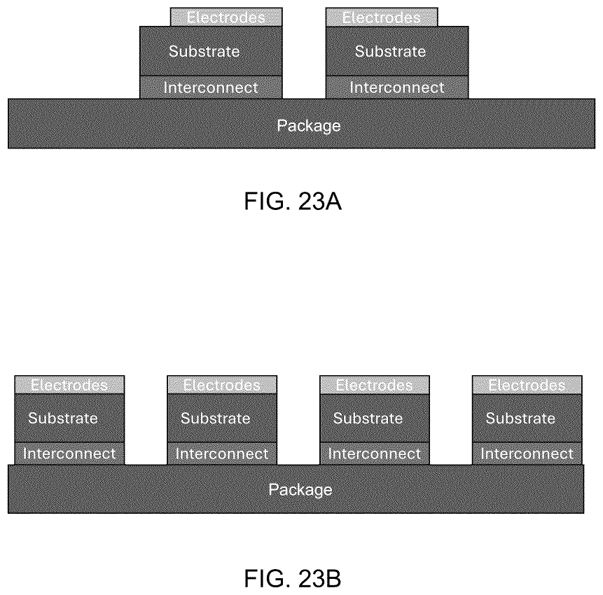

Illustrated in FIG. 23A are modules die-bonded to a package material. The modules comprise surface electrodes, a substrate, and an interconnect to attach the modules to the package material. The modules are configured to transport ions from one ion trap to another. FIG. 23B illustrates the scalability of the attachment of modules to a common package material. Neighboring modules can be placed at all four sides, or edges, of a module to scale the system illustrated in FIG. 23B in at least two dimensions. FIG. 23B is a cross-sectional view and shows modules with only two neighbors, however modules could be added in planes/axes extending through and out of the page as well, providing a 2D array of quantum computing modules.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A system for non-classical computing, comprising:
a first module adjacent to a second module and an inter-module gap therebetween, the first or the second module comprising:
a substrate; and
a plurality of electrodes disposed above the substrate and configured to trap an ion above a surface of the substrate,
wherein the first module and the second module are attached to a common package material by an interconnect.

2. The system of claim 1, wherein the first or the second module further comprises a ground plane layer disposed between the substrate and the plurality of electrodes, and wherein the ground plane layer is substantially at a voltage ground.

3. The system of claim 2, wherein the plurality of electrodes extends beyond the ground plane layer towards the inter-module gap.

4. The system of claim 1, wherein the first module and the second module are die-bonded to the common package material.

5. The system of claim 1, wherein the interconnect comprises a ball grid array, a pin grid array, a land grid array, a ceramic column grid array, a bumps array, a spring pin, or a direct bond interface.

6. The system of claim 1, wherein the substrate comprises one or more through-chip vias in electrical communication with the plurality of electrodes and configured to receive an electrical signal from a power source

7. The system of claim 6, wherein the power source is connected to the one or more through-chip vias on a side of the substrate opposite the plurality of electrodes.

8. The system of claim 1, wherein the plurality of electrodes comprises:
at least two RF electrodes disposed in an axis parallel to the direction of transport of the one or more ions; and
at least three RF ground electrodes disposed in one or more axes parallel to the direction of transport of the one or more ions, wherein a first RF ground electrode of the at least three RF ground electrodes is between the at least two RF electrodes, and wherein a second RF ground electrode and a third RF ground electrode are outside of the at least two RF electrodes.

9. The system of claim 8, wherein an RF ground electrode of the at least three RF ground electrodes comprises a plurality of sub-electrodes configured to provide one or both of confinement of an ion of the one or more ions along the direction of transport of the one or more ions or transport the ion of the one or more ions along the direction of transport of the one or more ions.

10. The system of claim 9, wherein the first RF ground electrode comprises a plurality of sub-electrodes along the direction of transport of the one or more ions.

11. The system of claim 8, wherein an oscillating voltage is applied to the at least two RF electrodes.

12. The system of claim 8, wherein a substantially constant voltage is applied to one or more of the at least three RF ground electrodes.

13. The system of claim 8, wherein the at least two RF electrodes are configured to confine an ion of the one or more ions in a direction perpendicular to the direction of transport of the one or more ions.

14. The system of claim 8, wherein the second and the third RF ground electrodes are grounds.

15. The system of claim 1, wherein the plurality of electrodes lies in a plurality of planes above a surface of the substrate and wherein the plurality of planes is non-coplanar.

16. The system of claim 15, wherein a first plane and a second plane of the plurality of planes is separated by at least about 1 μm.

17. The system of claim 1, further comprising a third module adjacent to the first module and forming a second inter-module gap therebetween.

18. The system of claim 1, wherein the first and second module comprise an alignment offset of less than about 10 μm in a direction perpendicular to a direction of ion transport.

19. The system of claim 1, wherein the plurality of electrodes extends beyond the substrate towards the inter-module gap.

20. The system of claim 19, wherein the plurality of electrodes extends beyond the substrate along an axis parallel to a direction of ion transport.
